(19) United States
(12) Patent Application Publication
(10) Pub. No.: US 2020/0406592 A1
(43) Pub. Date: Dec. 31, 2020

(54) POLYETHYLENE RECYCLABLE FILM WITH HIGH STRENGTH AND/OR BARRIER

(71) Applicant: Sealed Air Corporation (US), Charlotte, NC (US)

(72) Inventors: Richard Dayrit, Fort Mill, SC (US); Blaine C. Childress, Inman, SC (US); Eric Ellenbogen, Charlotte, NC (US); Arghavan V. Nawaby, Southlake, TX (US); Tori Motchan, Charlotte, NC (US); Eva Chu, Charlotte, NC (US)

(21) Appl. No.: 16/978,069

(22) PCT Filed: Mar. 6, 2019
(86) PCT No.: PCT/US2019/020940

§ 371 Date: Sep. 3, 2020

Related U.S. Application Data
(60) Provisional application No. 62/639,555, filed on Mar. 7, 2018.

(51) Int. Cl. B32B 27/08; B32B 3/04; B32B 7/027; B32B 7/05; B32B 27/32; B32B 27/30; B32B 27/34; B65D 27/00; B65D 27/14; B65D 65/40; B65D 81/03

(52) U.S. Cl. CPC B32B 27/08; B32B 2439/02; B32B 7/027; B32B 7/05; B32B 27/32; B32B 27/304; B32B 27/306; B32B 27/34; B65D 27/005; B65D 27/14; B65D 65/40; B65D 81/03; B32B 2250/24; B32B 2307/31; B32B 2307/41; B32B 2307/548; B32B 3/04

(57) ABSTRACT

Polyethylene recyclable composite article comprises multilayer film having first layer comprising polyolefin with a melting point ≤190° C., second layer comprising second polymer selected from amorphous polyamide, polyamide with melt point 191-205° C., polyvinylidene chloride w/melt point 191-205° C., and/or EVOH w/melt point 191-205° C., and tie layer between the first layer and the second layer. The multilayer film is bonded to itself or another component. The second polymer makes up 1 to 10 wt % of composite article weight, and composite article exhibits a composite melt index of from 0.5 to 4 grams/10 min at 190° C. and 2.16 kg in a Composite Melt Index Test. A corresponding polyethylene recyclable multilayer film also exhibits 0.5 to 4 grams/10 min at 190° C. and 2.16 kg in a Composite Melt Index Test.

### BACKGROUND

For some time there has been a growing demand for products offered by online suppliers who ship products directly to the consumer in response to an online order by the consumer, bypassing the traditional retail store. Some products are shipped in corrugated boxes (or other rigid or semi-rigid container) with cushioning and dunnage inside. Other products are shipped in envelope-type containers commonly referred to as “mailers.” Some mailers incorporate cushioning, while others are non-padded envelopes.

Mailers and other packaging articles have been made of (i) paper alone, (ii) plastic alone, and (iii) a composite including one or more paper components in combination with one or more plastic components. Recycling composites having both paper and plastic components is more difficult than recycling paper alone or plastic alone if the paper and plastic have to be separated in order to be recycled. Mailers and other packaging articles made primarily from polyethylene can be recycled with polyethylene if the article has a melt index of from 0.5 to 4 grams/10 minutes at 190° C. and 2.16 kg.

Mailers made solely from plastic films have included both non-padded envelopes made from a single type of film, as well as cushion mailers which are a composite of an envelope made from a first film having a first composition, bonded to a cushioning article such as BUBBLE WRAP cellular cushioning (or inflatable cushioning such as BUBBLE WRAP IB inflatable cushioning) made from a second film having a second composition. For reasons of economy and recyclability, polyolefins such as polyethylene and polypropylene have been the primary polymers used in mailers.

Films used in mailers and other packaging end uses (e.g., air pillows, etc) benefit from being strong, tough, and flexible on a per unit weight basis. The strength and toughness of relatively thin films can be enhanced by providing the film with a layer of a high strength polymer such as polyamide or some other polymer which is stronger, per unit weight, than polyolefins such as polyethylene and polypropylene.

Moreover, air cellular and inflatable cushioning articles benefit from being made with films having a barrier layer which is relatively impermeable to the component(s) of the gas inside the chambers, such as air, nitrogen, carbon dioxide, etc. Various air cellular cushioning articles made from films lacking a barrier layer, and inflatable cushioning articles made from films lacking a barrier layer, exhibit relatively high air loss from sealed chambers the cells over a period of, for example, 96 hours under a load of 1 psi. Resistance to this air loss is referred to as “creep resistance” in the industry. Air loss reduces the cushioning performance and stiffness of the cushioning article. For an air cellular article, the degree of creep resistance is proportional to the rate of transmission of air through the films from which the article is made.

It is known that air cellular articles made from polyolefin-based film exhibit lower creep if one or more films making up the air cellular articles possess one or more gas barrier layers. A layer of polyamide 6 is the most common strengthening layer and/or gas barrier layer utilized in packaging films, including films used to make air cellular cushioning articles for packaging, because it both provides low gas transmission properties at relatively low in cost for the amount of strength and/or gas barrier property it adds to a polyolefin based film.

It would be desirable to provide a film or packaging article which is polyethylene recyclable but also has added strength and higher gas barrier provided by high strength, semi-crystalline polymers such as polyamide.

### SUMMARY

It has been discovered that packaging films (and articles made therefrom) having one or more film layers made from polyamide 6, cannot be recycled with polyolefins such as polyethylene if the polyamide 6 makes up 3.1 wt % of the total weight of the article. The reason for this result appears to be that polyamide 6 has a melt point of 215° C. to 220° C., i.e., higher than the 190° C. temperature at which polyethylene recyclability is tested.

More particularly, whereas a 0% polyamide film made from about 55 wt % high density polyethylene and 45 wt % linear low density polyethylene exhibited a melt index of 0.58 g/10 min at 190° C. and 2.16 kg and therefore was considered to be polyethylene recyclable, a film made from about 65 wt % high density polyethylene and about 32 wt % other ethylene polymers in combination with a total of about 3.1 wt % of polyamide 6 polymers having melting points of 215° C. and 220° C. was found to exhibit a composite melt index of 0 g/10 min at 190° C. and 2.16 kg and therefore was considered not to be polyethylene recyclable.

It would be desirable to have a polyethylene-recyclable film or composite article with the strength and/or barrier properties similar to the strength and barrier properties of prior art polyethylene-based films containing a polyamide barrier polymer. However, polyethylene recyclability is generally incompatible with the presence of even a low amount of a polymer such as polyamide 6, which is one of the most common and least expensive of all polyamides. A composite article making up, for example, about 98.8 wt % polyolefin in combination about 1.2 wt % polyamide 6 with a melt point of 220° C. exhibited a melt index of only 0.06 g/10 min at 190 C and 2.16 kg, and accordingly was not polyethylene recyclable.

The inventors have discovered a polyethylene-recyclable multilayer film which is composed primarily of polyethylene-based polymer, with the film having a layer containing polyamide 6/66 having a melting point of 196° C. The layer may contain as much as 100 wt. % polyamide 6/66. The film can be (i) sealed to itself to make a packaging article, or (ii) bonded to another component to make an assembly which is useful as a packaging article, with the resulting packaging article being polyethylene recyclable. Polyethylene recyclability is met by a polyethylene-containing article that exhibits a composite melt index of from 0.5 to 4 grams/10 min at 190° C. and 2.16 kg, under ASTM D1238. The discovery of polyethylene recyclability of a blend of polyethylene and polyamide 6/66 was an unexpected discovery and was chemically unpredictable.

The polyethylene recyclable film and polyethylene recyclable packaging article the inventors have discovered is made from a multilayer film composed primarily of polyethylene-based polymer, which film is strengthened by the addition of a layer made from the polyamide or other suitable polymer. The inventors have discovered a multilayer film that is strengthened by a layer of a polymer stronger than polyethylene, the film being polyethylene recyclable even though it has a layer made with the strong polymer which is not polyethylene-based, and even though the polymer has a melting point higher than 190 C temperature at which the melt index of the composite is measured for determination of suitability for polyethylene recycle.

Applicants have also discovered a cellular cushioning article which both meets the standard for being polyethylene recyclable (i.e., exhibits a composite melt index of from 0.5 to 4 grams/10 min at 190° C. and 2.16 kg, under ASTM D1238) in combination with being creep-resistant to a level of less than 20% fluid loss upon being subjected to a static load of 1 psi for 96 hours at room temperature (23C) and 1 atm ambient pressure. The creep test being conducted as described hereinbelow, with unspecified parameters being in accordance with ASTM D2221.

In a cellular cushioning article, the combination of the polyethylene recyclability and creep-resistance has been found to be met by the presence of polyamide 6/66 copolymer, which provides the air cellular film(s) with high gas barrier properties. The polyamide copolymer has a higher melt point than the 190° C. temperature at which the composite melt index test is performed. It is surprising that the melt index is at least 0.5 g/10 min at 190° C. and 2.16 kg, in view of the fact that the composite melt index test is carried out at a temperature lower than the melting point of the polyamide present. Indeed, if the amount of polyamide copolymer is increased to a level of greater than 15 wt %, based on total weight of the polymer blend to be recycled, the melt index is below 0.5 g/10 min at 190° C. and 2.16 kg, and the air cellular mailer does not meet the polyethylene recycle standard.

In addition to additional strength and additional creep resistance, the inclusion of a barrier material in air cellular article aids in supply chain/inventory. The enhanced creep resistance permits various stacking arrays without deflation before the cushioning article leaves the plant or is formed into a mailer.

A first aspect is directed to a polyethylene recyclable composite article. The composite article comprises a multilayer film. The multilayer film comprises a first layer, a second layer, and a tie layer between the first layer and the second layer. The first layer comprises a first polymer. The first polymer comprises at least one polyolefin having a melting point ≤190° C. The second layer comprises a second polymer selected from the group consisting of: (i) amorphous polyamide having a Tg of from 120° C. to 180° C.; (ii) polyamide having a melting point of from 191° C. to 205° C.; (iii) polyvinylidene chloride having a melting point of from 191° C. to 205° C., and (iv) ethylene/vinyl alcohol copolymer having a melting point of from 191° C. to 205° C. The tie layer comprises at least one tie polyolefin selected from the group consisting of ethylene/unsaturated ester, modified polyolefin, and homogeneous ethylene/alpha-olefin copolymer, the tie layer being between the first layer and the second layer. The multilayer film: (a) is bonded to itself, or (b) the multilayer film is a first discrete component of the composite article and the multilayer film is bonded to a second discrete component of the composite article. The second polymer is present in the composite article in an amount of from 1 to 10 wt % based on total composite article weight. The composite article exhibits a composite melt index of from 0.5 to 4 g/10 min at 190° C. and 2.16 kg in a Composite Melt Index Test.

In an embodiment, the amorphous polyamide can have a Tg of from 125° C. to 160° C., or from 125° C. to 150° C., or from 125° C. to 140° C. In an embodiment, the ethylene/vinyl alcohol copolymer can have an ethylene content of less than 28 mole %.

In an embodiment, in the composite article the multilayer film is bonded to itself. In an embodiment, the bond of the multilayer film to itself a heat seal of the multilayer film to itself. In an embodiment, the composite article is a form fill seal packaging article comprising: (a) a backseam heat seal of the film to itself, the backseam heat seal running the length of the composite article, the backseam heat seal being a first heat seal; (b) a first end seal of an inside layer of the film to itself, the first end seal being at a first end of the composite article, the first end seal being a second heat seal; and (c) a second end seal of an inside layer of the film to itself, the second end seal being at a second end of the composite article, the second end seal being a third heat seal. In an embodiment, the first heat seal is a fin seal. In an embodiment, the first heat seal is a lap seal.

In an embodiment, the composite article comprises the multilayer film bonded to itself to form a closeable envelope suitable for use as a mailer. The composite article comprises a bottom fold of the multilayer film. The bottom fold of the multilayer film defines: (i) a bottom of the composite article, (ii) a front wall portion of the multilayer film extending from a first side of the bottom fold to a transverse top edge of the front wall, and (iii) a rear wall portion of the multilayer film extending from a second side of the bottom fold to a transverse top edge of the rear wall. The front wall portion of the multilayer film has a front wall inside layer facing the rear wall. The rear wall portion of the multilayer film has a rear wall inside layer facing the front wall. A first portion of the front wall inside layer is bonded to a first portion of the rear wall inside layer to make a first lateral bond along a first side edge of the article. A second portion of the front wall inside layer is bonded to a second portion of the rear wall inside layer to make a second lateral bond along a second side edge of the article. The composite article further comprises an open mouth for receiving a product. The open mouth is defined at least in part by a transverse top edge of the front wall.

In an embodiment, the rear wall comprises a closure flap that extends past the transverse top edge of the front wall. In an embodiment, the closure flap is an integral extension the multilayer film past the transverse top edge of the front wall. In an embodiment, the rear wall comprises a discrete extension member attached to the multilayer film. The discrete extension member forms at least a portion of the closure flap of the rear wall which extends past the transverse top edge of the front wall.

In an embodiment, in the composite article the multilayer film is a first multilayer film which forms a front wall of the composite article; the composite article further comprises a second film which forms a rear wall of the composite article; the first multilayer film and the second film are bonded to each other at a bottom seal defining a bottom, a first lateral seal along a first side edge, and at a second lateral seal along a second side edge, with the front wall extending from the bottom seal to a transverse top edge of the front wall, and the rear wall extending from the bottom seal to a transverse top edge of the rear wall; the composite article further comprises an open mouth for receiving a product, the open mouth being defined at least in part by the transverse top edge of the front wall. In a further embodiment, the rear wall comprises a closure flap that extends past the transverse film edge at the open end edge of the front wall. In an embodiment, the closure flap is an integral extension the second film past the open end edge of the front wall. In an alternative embodiment, the rear wall comprises a discrete extension member attached to the second film, the discrete extension member forming at least a portion of the closure flap of the rear wall that extends past the top edge of the front wall.

In an embodiment, the composite article further comprises an adhesive (e.g., a pressure-sensitive adhesive) on an interior surface of the closure flap. In an embodiment, the composite article further comprises a release tape over the adhesive on the interior surface of the closure flap.

In an embodiment, the front wall has a length corresponding with a distance from the bottom to the transverse top edge of the front wall, and the rear wall has a length corresponding with a distance from the bottom to a transverse top edge of the rear wall, with the length of the front wall being equal to the length of the rear wall, with the transverse top edge of the front wall and the transverse top edge of the rear wall define the open mouth for receiving the product. In an embodiment, a region of the inside surface of the rear wall has a pressure sensitive adhesive thereon. The region is along the transverse top edge of the rear wall, faces an inside surface of the front wall, and has a release tape thereon.

In an embodiment, the multilayer film is sealed to itself or another film in an assembly having at least closed one fluid-filled chamber, with the assembly being a cushioning article.

In an embodiment in which the cushioning article is a cellular cushioning article, the multilayer film is a first multilayer film which is a formed film having a plurality of formed regions separated by a land area, and the composite article is a cellular cushioning article further comprising a second film that is a backing film bonded to a land area of the formed film, so that a plurality of closed fluid-filled chambers are between the first multilayer film and the second film. In an embodiment, the second film is a second multilayer film comprising: (A) a third layer comprising a third polymer, the third polymer comprising polyolefin having a melting point ≤190° C., and (B) a fourth layer comprising a fourth polymer selected from the group consisting of: (i) amorphous polyamide having a Tg of from 120° C. to 180° C., (ii) polyamide having a melting point of from 191° C. to 205° C., (iii) polyvinylidene chloride having a melting point greater than 191° C. to 205° C., and (iv) ethylene/vinyl alcohol copolymer having a melting point of from 191° C. to 205° C. In an embodiment, the second film has at least one layer comprising a pigment and the second film is opaque to light within a wavelength range of 400 to 700 nanometers.

In an embodiment, the cellular cushioning article is laminated to an envelope film to form a cellular cushioning laminate. In an embodiment, the cellular cushioning laminate is in a folded configuration and has a fold defining: (i) a bottom of the composite article, (ii) a front wall extending from a first side of the bottom fold, (iii) a rear wall extending from a second side of the bottom fold; and the front wall faces the rear wall, wherein: (iv) a first portion of the front wall is bonded to a first portion of the rear wall to make a first lateral bond along a first side edge of the composite article, and (v) a second portion of the front wall is bonded to a second portion of the rear wall to make a second lateral bond along a second side edge of the composite article; with the cellular cushioning article having open mouth for receiving a product, the open mouth defined at least in part by a transverse top edge of the front wall. In an embodiment, the envelope film is an outside component of the cellular cushioning laminate, and the cellular cushioning article is an inside component of the composite article. In an embodiment, the envelope film is multilayer and has at least one layer comprising a pigment, with the envelope film being opaque to light within a wavelength range of 400 to 700 nanometers.

In an embodiment, the composite article comprising the cellular cushioning laminate has the cellular cushioning article as an outside component of the cellular cushioning laminate, with the backing film of the cellular cushioning article being an outside film of the composite article, the backing film being multilayer and having at least one layer comprising a pigment, the backing film being opaque to light within a wavelength range of 400 to 700 nanometers.

In an embodiment, the rear wall of the composite article comprising the cellular cushioning laminate further comprises a closure flap that extends past the transverse open end edge of the front wall. In an embodiment, the closure flap is an integral extension comprising at least the back wall outside component. In an embodiment, the rear wall has an extension member attached thereto, the extension member forming at least a portion of the closure flap of the rear wall that extends past the open end edge of the front wall.

In an embodiment, the composite article comprises (i) a first cellular cushioning article laminated to a first envelope film to make a first cellular cushioning laminate, with the first cellular cushioning laminate forming a front wall of the composite article, (ii) a second cellular cushioning laminated to a second envelope film to make a second cellular cushioning laminate, with the second cellular cushioning laminate comprising a second cellular cushioning article laminated to a second envelope film; laminated to a second cellular cushioning article; wherein the first cellular cushioning laminate and the second cellular cushioning laminate are bonded to each other at a bottom seal defining a bottom of the composite article, at a first lateral seal along a first side edge of the composite article, and at a second lateral seal along a second side edge of the composite article, and the composite article further comprises an open mouth for receiving a product, the open mouth being defined at least in part by a transverse top edge of the front wall.

In an embodiment, the first and second envelope films are outside components of the first and second cellular cushioning laminates, respectively, and the first and second cellular cushioning articles are inside components of the composite article. In an embodiment, the envelope films are multilayer each having at least one layer comprising a pigment, with the envelope film being opaque to light within a wavelength range of 400 to 700 nanometers.

In an embodiment, the first and second envelope films are inside components of the first and second cellular cushioning laminates, respectively, and the first and second cellular cushioning articles are outside components of the composite article. In an embodiment, the backing films of the first and second cellular cushioning articles are outside films of the composite article, and the backing films of the first and second cellular cushioning articles are multilayer backing films, and each multilayer backing film has at least one layer comprising a pigment, and each multilayer backing film is opaque to light within a wavelength range of 400 to 700 nanometers.

In an embodiment of the composite article comprising the first and second cellular cushioning laminates, the rear wall comprising the second cellular cushioning laminate further comprises a closure flap that extends past the transverse open end edge of the front wall. In an embodiment, the closure flap is an integral extension comprising at least the rear wall outside component. In an embodiment, the cellular cushioning laminate of the rear wall has an extension member attached thereto, the extension member forming at least a portion of the closure flap of the rear wall that extends past the open end edge of the front wall. In an embodiment, the, the closure flap further comprises an adhesive on an interior surface thereof. In an embodiment, the composite article further comprises a release tape over the adhesive on the interior surface of the closure flap.

In an embodiment of the composite article comprises the folded cellular cushioning laminate or the composite article comprising the first and second cellular cushioning laminates: (i) the front wall of the composite article has a length corresponding with a distance from the bottom to the transverse top edge of the front wall, (ii) the rear wall of the composite article has a length corresponding with a distance from the bottom to a transverse top edge of the rear wall, (iii) the length of the front wall is equal to the length of the rear wall, and (iv) the transverse top edge of the front wall and the transverse top edge of the rear wall define the open mouth for receiving the product. In an embodiment, a region of the inside surface of the rear wall has a pressure sensitive-adhesive thereon, the region being along the transverse top edge of the rear wall, the region facing an inside surface of the front wall, with the pressure-sensitive adhesive having a release tape thereon.

In an embodiment, the composite article comprises the cellular cushioning article in a folded configuration, with the fold defining: (i) a bottom edge of the composite article, (ii) a front wall extending from a first side of the bottom fold, and (iii) a rear wall extending from a second side of the bottom fold. The front wall faces the back wall, and (iv) a first portion of the front wall is bonded to a first portion of the rear wall to make a first lateral bond along a first side edge of the cellular cushioning article, and (v) a second portion of the front wall is bonded to a second portion of the rear wall to make a second lateral bond along a second side edge of the cellular cushioning article. The cellular cushioning article further comprises an open mouth for receiving a product, the open mouth defined at least in part by a transverse top edge of the front wall. In an embodiment, the backing film is an outside film of the composite article. In an embodiment, the backing film has at least one layer comprising a pigment, and the backing film is opaque to light within a wavelength range of 400 to 700 nanometers.

In an embodiment: the composite article comprises a first cellular cushioning article that forms a front wall of the composite article, and a second cellular cushioning article that forms a rear wall of the composite article, with the first cellular cushioning article and the second cellular cushioning article being bonded to each other at a bottom seal defining a bottom, at a first lateral seal along a first side edge, and at a second lateral seal along a second side edge, with the composite article further comprising an open mouth for receiving a product, the open mouth being defined at least in part by a transverse top edge of the front wall. In an embodiment, the backing film of the first cellular cushioning article is a first outside film of the composite article, and the backing film of the second cellular cushioning article is a second outside film of the composite article. In an embodiment, the backing film of the first cellular cushioning article has at least one layer comprising a pigment and is opaque to light within a wavelength range of 400 to 700 nanometers, and the backing film of the second cellular cushioning article has at least one layer comprising a pigment and is opaque to light within a wavelength range of 400 to 700 nanometers.

In an embodiment, the cellular cushioning article in folded configuration or the cellular cushioning article comprising the second cellular cushioning article forming the rear wall further comprises a closure flap that extends past the transverse edge of the front wall. In an embodiment, the closure flap is an integral extension comprising at least the backing film of the rear wall. In an embodiment, the rear wall has an extension member attached thereto, the extension member forming at least a portion of the closure flap of the rear wall that extends past the open end edge of the front wall. In an embodiment, the composite article further comprises an adhesive on an interior surface of the closure flap. In an embodiment, the interior surface of the closure flap has a release tape over the adhesive.

In an embodiment: (i) the cellular cushioning article (or portion thereof) forming the front wall of the composite article has a length corresponding with a distance from the bottom to the transverse top edge of the front wall, (ii) the cellular cushioning article (or portion thereof) forming the rear wall of the composite article has a length corresponding with a distance from the bottom to a transverse top edge of the rear wall, (iii) the length of the front wall is equal to the length of the rear wall, and (iv) the transverse top edge of the front wall and the transverse top edge of the rear wall define the open mouth for receiving the product. In an embodiment, a region of the inside surface of the rear wall has a pressure sensitive-adhesive thereon, the region being along the transverse top edge of the rear wall, the region facing an inside surface of the front wall, with the pressure-sensitive adhesive having a release tape thereon.

In an embodiment, the composite article comprises an inflatable cellular cushioning article. In an embodiment, the inflatable article comprises the multilayer film in a folded configuration, the multilayer film being bonded to itself in a seal pattern defining a series of inflatable chambers having a closed distal end and an open proximal end providing an inflation port for each inflatable chamber, with each inflatable chamber comprising a plurality of inflatable cells connected by inflatable connecting channels, with each chamber terminating at a terminal cell.

In an embodiment of the inflatable cellular cushioning article, the inflatable article comprises (i) the folded multilayer film bonded to itself in the seal pattern defining the series of inflatable chambers, and/or (ii) the first multilayer film and/or the second multilayer film bonded to each other, have thermoformed regions thereon. The thermoformed regions correspond with the plurality of inflatable cells that make up the plurality of inflatable chambers. In an embodiment, the folded multilayer film, or at least one of the first multilayer film and the second multilayer film, further comprise thermoformed connecting channels between the thermoformed regions corresponding with the plurality of inflatable cells making up at least the plurality of inflatable chambers.

In an embodiment, the inflatable article comprises the multilayer film in a folded configuration with a fold defining: (i) a bottom; (ii) a front wall extending from the bottom to a first transverse edge defining an open front wall edge; and (iii) a rear wall extending from the bottom to a second transverse edge defining an open rear wall edge; and the front wall faces the back wall, wherein: (iv) a first portion of the front wall is bonded to a first portion of the rear wall to make a first lateral bond along a first side edge of the cellular cushioning article; (v) a second portion of the front wall is bonded to a second portion of the rear wall to make a second lateral bond along a second side edge of the cellular cushioning article; and the inflatable article further comprises an open mouth for receiving an inflation fluid, the open mouth being defined at least in part by the first transverse edge defining the open front wall edge. In an embodiment, the inflatable article is in a strand comprising a plurality of inflatable articles, each separated from the other by one or more transverse seals across the strand.

In an embodiment of the inflatable cellular cushioning article, the multilayer film is a first multilayer film and the inflatable article further comprises a second multilayer film, and the first multilayer film is bonded to the second multilayer film in a seal pattern defining a series of inflatable chambers having a closed distal end and an open proximal end providing an inflation port for each inflatable chamber, with each inflatable chamber comprising a plurality of inflatable cells connected by inflatable connecting channels, with each chamber terminating at a terminal cell.

In an embodiment of the inflatable cellular cushioning article comprising the first and second multilayer films, the second multilayer film comprises: (A) a first layer comprising a first polymer, the first polymer comprising polyolefin having a melting point ≤190° C., and (B) a second layer comprising a second polymer selected from the group consisting of: (b)(i) amorphous polyamide having a Tg of from 120° C. to 180° C., (b)(ii) polyamide having a melting point of from 191° C. to 205° C., (b)(iii) polyvinylidene chloride having a melting point greater than 191° C. to 205° C., and (b)(iv) ethylene/vinyl alcohol copolymer having a melting point of from 191° C. to 205° C.

In an embodiment of the inflatable article, the multilayer film is a first multilayer film that forms a front wall of the inflatable article and the composite article further comprises a second multilayer film that forms a rear wall of the inflatable article, and the first multilayer film and the second multilayer film are bonded to each other (i) at a bottom seal defining a bottom, (ii) at a first lateral seal along a first side edge, and (iii) at a second lateral seal along a second side edge, and the composite article further comprises an open mouth for an inflation fluid, the open mouth being defined at least in part by a transverse top edge of the front wall. In an embodiment, the second multilayer film comprises: (A) a third layer comprising a first polymer, the first polymer comprising polyolefin having a melting point ≤190° C., and (B) a fourth layer comprising a second polymer selected from the group consisting of: (b)(i) amorphous polyamide having a Tg of from 120° C. to 180° C., (b)(ii) polyamide having a melting point of from 192° C. to 205° C., (b)(iii) polyvinylidene chloride having a melting point greater than 192° C. to 205° C., and (b)(iv) ethylene/vinyl alcohol copolymer having a melting point of from 192° C. to 205° C. In an embodiment, the inflatable article is in a strand comprising a plurality of inflatable articles, each separated from the other by one or more transverse seals across the strand.

In an embodiment, the composite article is a strand comprising a matrix of closed fluid-filled chambers. In an embodiment, the strand comprising the matrix of fluid-filled chambers comprises the multilayer film in a folded configuration so that the composite article comprises: (a) a folded edge running the length of the strand, with the multilayer film having an inside layer and an outside layer; (b) a top seal of the inside layer of the multilayer film to itself, the top seal running the length of the strand; (c) at least one internal seal running the length of the strand, the internal seal being between the folded edge and the top seal; and (d) a plurality of lateral seals across the strand.

In an embodiment, the multilayer film is a first multilayer film in the strand comprising the matrix of fluid-filled chambers, with the strand further comprising a second multilayer film, with an inside layer of the first multilayer film being bonded to an inside layer of the second multilayer film at (i) a first edge seal running along a first lengthwise edge of the strand (ii) a second edge seal running along a second lengthwise edge of the strand, (iii) at least one internal seal running the length of the strand, the internal seal being between the first edge seal and the second edge seal, and (iv) a plurality of lateral seals across the strand. In an embodiment, the second multilayer film comprises: (A) a first layer comprising a first polymer, the first polymer comprising polyolefin having a melting point ≤190° C., and (B) a second layer comprising a second polymer selected from the group consisting of: (b)(i) amorphous polyamide having a Tg of from 120° C. to 180° C., (b)(ii) polyamide having a melting point of from 191° C. to 205° C., (b)(iii) polyvinylidene chloride having a melting point greater than 191° C. to 205° C., and (b)(iv) ethylene/vinyl alcohol copolymer having a melting point of from 191° C. to 205° C.

In an embodiment, in the cellular cushioning article the closed fluid-filled chambers contain air. In an embodiment, the closed fluid-filled chambers exhibit a creep resistance of less than 50% when placed under a load of 1 psi for 96 hours, the percent creep resistance being carried out in accordance with ASTM D2221. In an embodiment, the closed fluid-filled chambers exhibit a creep resistance of less than 40%, or less than 30%, or less than 25%, or less than 20%, or from 5 to 20%, or from 10 to 20%, or from 15 to 20%, when placed under a load of 1 psi for 96 hours, the percent creep resistance being carried out in accordance with ASTM D2221.

In an embodiment of the inflatable cushioning article, wherein upon filling the inflatable chambers with air and sealing them closed to provide an inflated cushioning article, the inflated, sealed chambers exhibit a creep resistance of less than 50% when placed under a load of 1 psi for 96 hours, the percent creep resistance being carried out in accordance with ASTM D2221. In an embodiment, the sealed fluid-filled chambers exhibit a creep resistance of less than 40%, or less than 30%, or less than 25%, or less than 20%, or from 5 to 20%, or from 10 to 20%, or from 15 to 20%, when placed under a load of 1 psi for 96 hours, the percent creep resistance being carried out in accordance with ASTM D2221.

In an embodiment, the second layer of the multilayer film comprises the at least one second polymer in an amount of at least 90 wt %, based on total layer weight. In an embodiment, the second layer of the multilayer film comprises the at least one second polymer in an amount of at least 95 wt %, or at least 98 wt %, or at least 99 wt %, or 100 wt %, based on the weight of the second layer.

In an embodiment, the at least one second polymer is present in the multilayer film in an amount of from 1.5 to 7 wt %, based on total weight of the composite article. In an embodiment, the at least one second polymer is present in the multilayer film in an amount of from 1.7 to 5 wt %, or 2 to 4 wt %, or from 2.5 to 3.5 wt %, based on total weight of the composite article.

In an embodiment, the multilayer film comprises polypropylene in an amount of from 1 to 7 wt %, based on total film weight. In an embodiment, the multilayer film comprises polypropylene in an amount of from 2 to 5 wt %, or 2 to 4 wt %, based on total film weight.

In an embodiment, the multilayer film comprises polypropylene in an amount of from 1 to 7 wt %, based on total film weight. In an embodiment, the multilayer film comprises polypropylene in an amount of from 2 to 5 wt %, or 2 to 4 wt %, or 3 to 4 wt %, based on total film weight.

In an embodiment, the, polyolefin having a melting point ≤190° C. comprises at least one member selected from the group consisting of high density polyethylene, linear low density polyethylene, medium density polyethylene, low density polyethylene, very low density polyethylene, ethylene/alpha-olefin copolymer having a density less than 0.92 g/cc, homogeneous ethylene/alpha-olefin copolymer, and polypropylene.

In an embodiment, the composite article has a total polyolefin content of from 90 to 99 wt % based on total composite article weight. In an embodiment, the composite article has a total polyolefin content of from 92 to 98.5 wt %, or from 94 to 98 wt %, or from 96 to 98 wt %, based on total composite article weight.

In an embodiment, the composite article has a Calculated Composite Melt Index at 190° C. and 2.16 kg of from 2 to 7 g/10 min. In an embodiment, the composite article has a Calculated Composite Melt Index at 190° C. and 2.16 kg of from 2.2 to 5 g/10 min, or from 2.5 to 3.5 g/10 min.

A second aspect is directed to a polyethylene recyclable multilayer film comprising: (A) a first layer comprising a first polymer, the first polymer comprising polyolefin having a melting point ≤190° C., (B) a second layer comprising a second polymer selected from the group consisting of: (b)(i) amorphous polyamide having a Tg of from 120° C. to 180° C., (b)(ii) polyamide having a melting point of from 191° C. to 205° C., (b)(iii) polyvinylidene chloride having a melting point greater than 191° C. to 205° C., and (b)(iv) ethylene/vinyl alcohol copolymer having a melting point of from 191° C. to 205° C., and (C) a tie layer comprising at least one tie polyolefin selected from the group consisting of ethylene/unsaturated ester, modified polyolefin, and homogeneous ethylene/alpha-olefin copolymer, the tie layer being between the first layer and the second layer, wherein the second polymer is present in the multilayer film in an amount of from 1 to 10 wt % based on total film weight, and wherein the multilayer film exhibits a composite melt index of from 0.5 to 4 g/10 min at 190° C. and 2.16 kg in a Composite Melt Index Test.

In an embodiment, the second layer of the polyethylene recyclable multilayer film comprises the at least one second polymer in an amount of at least 90 wt %, based on total layer weight. In an embodiment, the second layer of the multilayer film comprises the at least one second polymer in an amount of at least 95 wt %, at least 98 wt %, at least 99 wt %, 100 wt %, based on total layer weight.

In an embodiment, the at least one second polymer is present in the polyethylene recyclable multilayer film in an amount of from 1.5 to 7 wt %, based on total film weight. In an embodiment, the at least one second polymer is present in the polyethylene recyclable multilayer film in an amount of from 1.7 to 5 wt %, or 2 to 4 wt %, or 2.5 to 3.5 wt %, based on total film weight.

In an embodiment, the polyethylene recyclable multilayer film comprises polypropylene in an amount of from 1 to 7 wt %, based on total film weight. In an embodiment, the polyethylene recyclable multilayer film comprises polypropylene in an amount of from 2 to 5 wt %, or from 3 to 4 wt %, based on total film weight.

In an embodiment, the polyethylene recyclable multilayer film comprises the polyolefin having a melting point ≤190° C. comprises at least one member selected from the group consisting of high density polyethylene, linear low density polyethylene, medium density polyethylene, low density polyethylene, very low density polyethylene, ethylene/alpha-olefin copolymer having a density less than 0.92 g/cc, homogeneous ethylene/alpha-olefin copolymer, and polypropylene.

In an embodiment, the polyethylene-recyclable multilayer film has a total polyolefin content of from 90 to 99 wt % based on total film weight. In an embodiment, the polyethylene-recyclable multilayer film has a total polyolefin content of from 92 to 98.5 wt %, or from 94 to 98 wt %, or from 96 to 98 wt %, based on total film weight.

In an embodiment, the polyethylene-recyclable multilayer film has a Calculated Composite Melt Index of from 2 to 7 g/10 min at 190° C. and 2.16 kg. In an embodiment, the polyethylene-recyclable multilayer film has a Calculated Composite Melt Index of from 2.2 to 5 g/10 min, or from 2.5 to 3.5 g/10 min, at 190° C. and 2.16 kg.

### BRIEF DESCRIPTION OF THE DRAWINGS

FIG. 1 is a perspective view of a polyethylene recyclable envelope with a closure flap in an open position.

FIG. 2 is a front plan view of an alternative polyethylene recyclable envelope similar to the polyethylene recyclable envelope of FIG. 1, illustrating the closure flap in a closed position, and an outer ply of the front wall of the envelope partially cut away to disclose its construction.

FIG. 3 is a rear plan view of the polyethylene recyclable envelope of FIG. 2, with the closure flap in a closed position, and an outer ply of the rear wall of the envelope partially cut away to disclose its construction.

FIG. 4 is a front plan view of the polyethylene recyclable envelope of FIGS. 2 and 3, with the closure flap in an open position, and with a portion of the front wall of the envelope partially cut away to disclose its construction.

FIG. 5 is a partial cross-sectional cut-away view of the polyethylene recyclable envelope of FIG. 2, taken along lines 5-5 of FIG. 2.

FIG. 6 is a schematic cross-sectional view of a multilayer laminate useful as a front or rear wall of the envelopes of FIGS. 1-5.

FIG. 7A is an exploded perspective view of a polyethylene recyclable air chamber article suitable for use as a cushioning article for packaging.

FIG. 7B is a transverse cross-sectional view taken through section 7B-7B2 perspective view of a first embodiment of a recyclable air chamber article suitable for use as a cushioning article for packaging.

FIG. 8 is a schematic of an integrated process for making an air cellular article including a downward cast processes for making both the formed film and the backing film portions of the composite air cellular article.

FIG. 9 is a perspective view of a first embodiment of a polyethylene recyclable air chamber article comprising a strand of pillows, and is suitable for use as a cushioning article for packaging.

FIG. 10 is a perspective view of a second embodiment of a polyethylene recyclable air chamber article comprising a strand of pillows, and is suitable for use as a cushioning article for packaging.

FIG. 11 is a plan view of an uninflated, inflatable polyethylene recyclable cellular cushioning article suitable for packaging and other end uses.

FIG. 12 is a perspective view of a recyclable air chamber article having a grid of pillows separated by lengthwise and transverse seals.

FIG. 13 is a schematic of a recyclable flow wrap package.

FIG. 14 is a cross-sectional view of the flow wrap package of FIG. 13, taken through section 14-14 of FIG. 13.

FIG. 15 is a schematic of another embodiment of a recyclable flow wrap package.

FIG. 16 is a cross-sectional view of the flow wrap package of FIG. 15, taken through section 16-16 of FIG. 15.

FIG. 17 is a schematic of a hot blown film process for making films to be used in the polyethylene recyclable article.

FIG. 18 is a schematic of a process for making a cast, solid-state oriented polyethylene recyclable film which can be used by itself as a film or composite article, or as a component of a composite article which is polyethylene recyclable.

### DETAILED DESCRIPTION

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

As used herein, the phrase “composite article” refers to an article made by sealing a multilayer film to itself, or by sealing a multilayer film to another component of the article.

As used herein, the noun “bond” and the verb “to bond” and “bonded” include all forms of bonding, including the many forms of heat sealing (e.g., impulse sealing, laser sealing, trim sealing, etc) as well as adhesive bonding. As used herein, the terms “bond” and “seal” are used interchangeably, both covering bonding by heat and bonding using adhesive. The phrase “heat seal” refers to a bond made using heat and pressure.

As used herein, all references to ASTM tests correspond with the most recent version of the ASTM test as of Feb. 1, 2018.

As used herein, the phrase “polyethylene recyclable,” as applied to a composite article which is either (a) a multilayer film or (b) an assembly of a multilayer film and a second component, refers to those multilayer films and assemblies which exhibit a composite melt index of 0.5 to 4 grams/10 min pushed through a 2 mm die at 190° C. with 2.16 kg mass in the Composite Melt Index Test described hereinbelow. That the melt index is a “Composite” melt index means that the composite article tested can be either (i) a multilayer film bonded to itself to form a packaging article, or (ii) an assembly comprising a multilayer film bonded to a second component to form a packaging article. In the assembly, the multilayer film may be the same as or different from the second component, so long as the multilayer film is discrete from the second component, The second component may itself be an assembly of two or more subcomponents.

As used herein, the symbols “Tg” and “T_{g}” are used with reference to the glass transition temperature of a polymer. Unless otherwise indicated, the glass transition temperature of the polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

As used herein, the phrase “cushioning article” includes air film containing articles that are used to cushion a product inside a package during storage and/or shipping. This phrase is inclusive of (i) cushioning articles which bear the weight of the product in the package and are capable of absorbing energy if the package impacts, or is impacted by, another object, and (ii) cushioning articles which secure and stabilize against lateral and/or vertical movement of the product inside the package, and are capable of absorbing energy if the package impacts, or is impacted by, another object, i.e., dunnage.

As used herein, the phrase “fluid-filled chamber” refers to a closed chamber (i.e., airtight chamber having a hermetic closure seal or seals) which is filled with fluid. The fluid can be gas or liquid or a combination of gas and liquid. The fluid-filled chamber is readily deformable when subjected to continuous or intermittent force, and thereby provides a cushioning function relative to a product in contact therewith.

As used herein, the term “matrix” is used with reference to a cushioning article strand having a plurality of discrete cells across the strand as well as a plurality of discrete cells along the length of the strand, with the cells of the strand being arranged as an array.

As used herein, the phrase “tie layer” refers to any internal layer having the primary purpose of adhering two layers to one another. Tie layers can comprise any polymer having a polar group grafted thereon. Such polymers adhere to both nonpolar polymers such as polyolefin, as well as polar polymers such as polyamide and ethylene/vinyl alcohol copolymer. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer.

The term “mailer” as used herein refers to packaging articles for the mailing of products direct from internet-based distributors to consumers. Such packaging articles include envelopes made by folding a flat film to form a bottom, with sides extending outwardly from each side of the fold to provide an envelope front side and an envelope rear side, with side seals made up the side edges of the envelope, with a closure flap extending from the back side of the envelope. Other mailers bond two separate pieces of film together to make the envelope, these mailers having a bottom seal and first and second side seals, together with an open top having a closure flap. Other mailers are made by sealing and cutting across a seamless film tubing, and still others are made by wrapping a flat film around a collar or the product followed by making a seal along the length of the envelope to form a backseamed tubing, followed by making transverse seals across the backseamed tubing to form end seals, with the product being inserted before making the final transverse bond or seal that fully closes the envelope so that the product is ready for mailing. Closure flaps are common on these mailers. Mailers are made in both “uncushioned” versions and “cushioned” versions. The cushioned versions typically have a liner containing an inner air cellular cushioning material.

The phrase “air chamber article” as used herein includes cushioning material, such as BUBBLE WRAP® cellular cushioning manufactured by Sealed Air Corporation. As an example, see U.S. Pat. No. 9,017,799, which is hereby incorporated, in its entirety, by reference thereto. BUBBLE WRAP® cellular cushioning comprises one film (the “formed film”) which is bonded to another film (the “backing film”). Conventional methods of making cellular cushioning have utilized a combination of heat and vacuum to thermoform the discrete regions, as described in U.S. Pat. No. 3,294,387, to Chavannes.

The formed film can be thermoformed (or calendered, etc) to provide a plurality of discrete formed regions separated by a “land area.” The discrete formed regions appear as protrusions when viewed from one side of the formed film, and as cavities when viewed from the other side (i.e., the “backside”) of the formed film. In one embodiment the protrusions are regularly spaced and have a cylindrical shape, with a round base and a domed top. In one embodiment, the backing film is a flat film, i.e., is not thermoformed. In another embodiment, the backing film also has discrete formed regions separated by a land area, with the land areas of the backsides of the two formed films being laminated to one another to form a “double bubble” air cellular product. In double bubble air cellular articles, the cavities of the first formed film may be fully aligned with respective cavities of the second formed film; alternatively, the cavities may be partially aligned/partially offset from each other; alternatively, the cavities may be fully offset from each other. Air cellular cushioning articles are designed to have formed cells containing air at ambient pressure, i.e., at the air pressure of the ambient environment in which the manufacturing process takes place.

The phrase “air chamber article” also include cushioning articles resulting from sealing two films (or the two leaves of a folded film, or a lay-flat tubing slit open along one lay-flat edge) together in a pattern of discrete sealed area(s) that leave a plurality of open inflatable chambers between the films. The inflatable article is generally shipped uninflated to the initial use destination, and stored uninflated at the initial use destination, in order to increase the efficiencies of storage and shipment. Inflatable air chamber cushioning articles are generally, but not always, designed to be inflated to superatmospheric pressure, i.e., the inflated chambers are designed to be inflated to an air pressure higher than the air pressure of the ambient environment in which the inflation and closure sealing takes place.

When being readied for use, the open inflatable chambers are inflated and sealed closed. The chambers may be of one or more of a variety of forms, including: (a) chambers of uniform size their length and/or width, and/or (b) chambers of non-uniform size along their length and width, particularly chambers made up of a plurality of inflated cells connected by connecting channels. Various inflatable air chamber cushioning articles for use in packaging and other end uses are disclosed in U.S. Pat. No. 3,660,189 (Troy), U.S. Pat. Nos. 4,576,669 and 4,579,516 (Caputo), U.S. Pat. No. 4,415,398 (Ottaviano), U.S. Pat. Nos. 3,142,599, 3,508,992, 3,208,898, 3,285,793, and 3,616,155 (Chavannes), U.S. Pat. No. 3,586,565 (Fielding), U.S. Pat. No. 4,181,548 (Weingarten), U.S. Pat. No. 4,184,904 (Gaffney), U.S. Pat. No. 6,800,162 (Kannankeril), U.S. Pat. No. 7,225,599 (Sperry), each of which is hereby incorporated, in its entirety, by reference thereto.

“Ethylene homopolymer or copolymer” herein refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; ethylene/(meth)acrylic acid copolymer; or ionomer resin.

“Ethylene/alpha-olefin copolymer” (EAO) herein refers to copolymers of ethylene with one or more comonomers selected from C₄ to C₁₀ alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ or ATTANE™ resins supplied by Dow, ESCORENE™ or EXCEED™ resins supplied by Exxon; as well as linear homogeneous ethylene/alpha olefin copolymers (HEAO) such as TAFMER™ resins supplied by Mitsui Petrochemical Corporation, EXACT™ resins supplied by Exxon, or long chain branched (HEAO) AFFINITY™ resins supplied by the Dow Chemical Company, or ENGAGE™ resins supplied by DuPont Dow Elastomers.

“High density polyethylene” (HDPE) herein refers to a polyethylene having a density of between 0.94 and 0.965 grams per cubic centimeter.

“Intermediate” herein refers to a layer of a multi-layer film which is between an outer layer and an inner layer of the film.

“Inner layer” herein refers to a layer which is not an outer or surface layer, and is typically a central or core layer of a film.

“Linear low density polyethylene” (LLDPE) herein refers to polyethylene having a density between 0.917 and 0.925 grams per cubic centimeter.

“Linear medium density polyethylene” (LMDPE) herein refers to polyethylene having a density between 0.926 grams per cubic centimeter and 0.939 grams per cubic centimeter.

“Outer layer” herein refers to what is typically an outermost, usually surface layer or skin layer of a multi-layer film, although additional layers, coatings, and/or films can be adhered to it.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 69 (homopolycondensate based on hexamethylene diamine and azelaic acid), polyamide 610 (homopolycondensate based on hexamethylene diamine and sebacic acid), polyamide 612 (homopolycondensate based on hexamethylene diamine and dodecandioic acid), polyamide 11 (homopolymer based on 11-aminoundecanoic acid), polyamide 12 (homopolymer based on w-aminododecanoic acid or on laurolactam), polyamide 6/12 (polyamide copolymer based on ε-caprolactam and laurolactam), polyamide 6/66 (polyamide copolymer based on ε-caprolactam and hexamethylenediamine and adipic acid), polyamide 66/610 (polyamide copolymers based on hexamethylenediamine, adipic acid and sebacic acid), modifications thereof and blends thereof. Said term also includes crystalline or partially crystalline, aromatic or partially aromatic, polyamides.

“Polymer” herein refers to homopolymer, copolymer, terpolymer, etc. “Copolymer” herein includes copolymer, terpolymer, etc.

All compositional percentages used herein are presented on a “by weight” basis, unless designated otherwise.

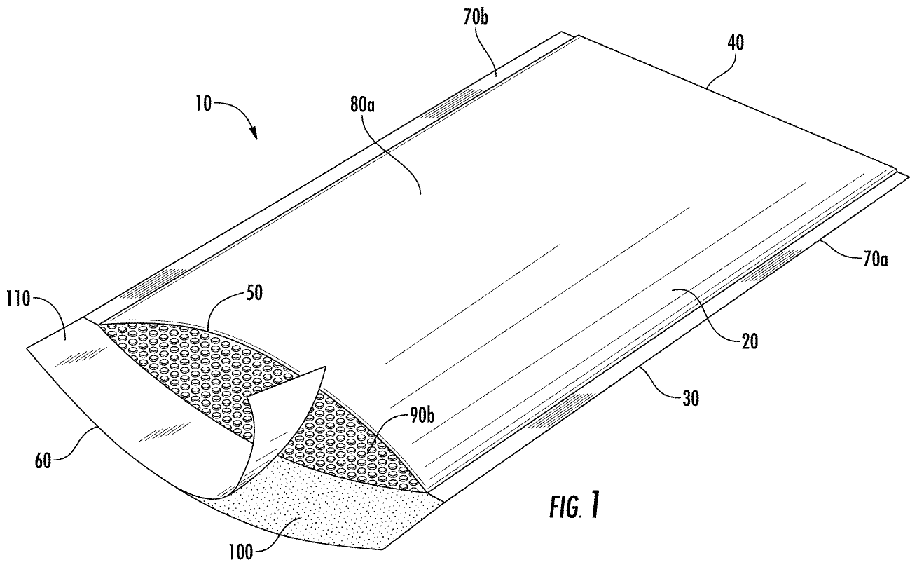

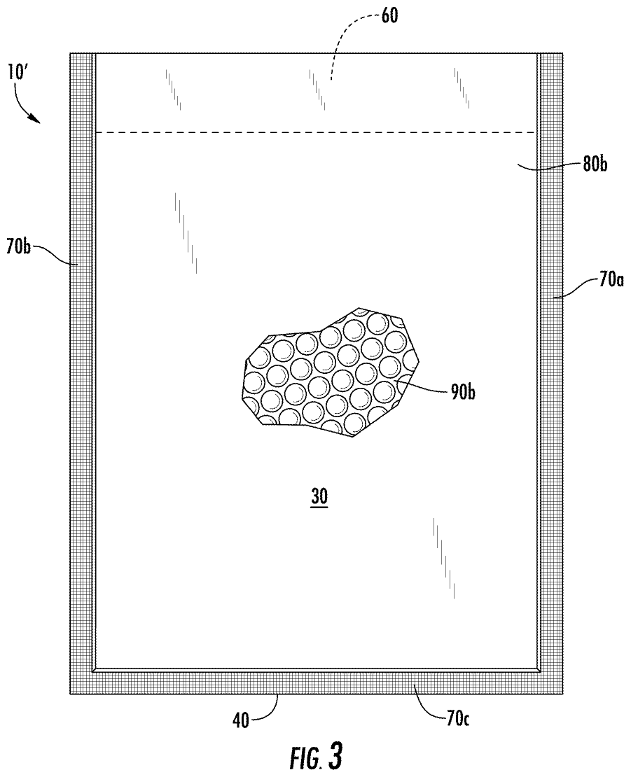

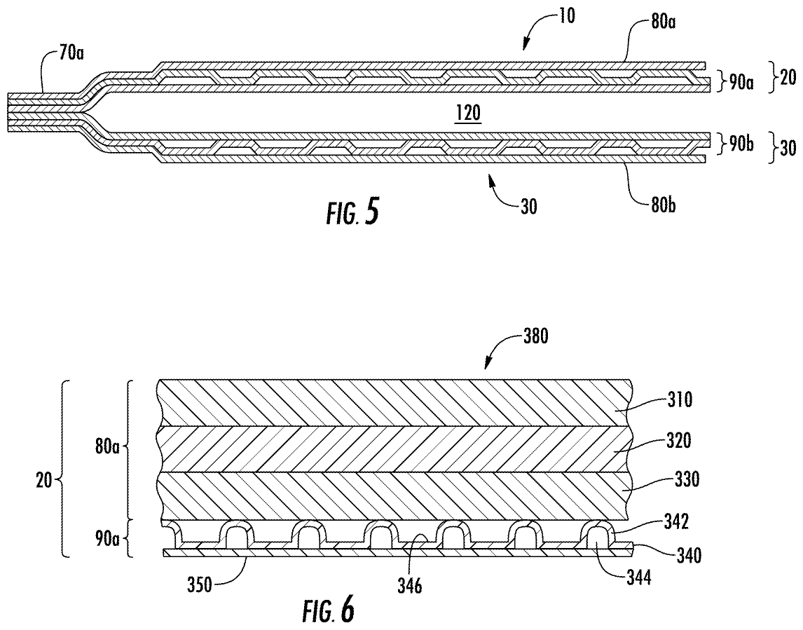

FIG. 1 is a perspective view of recyclable article 10 formed from a composite web folded upon itself and sealed along its two lateral edges. Recyclable article 10 is designed to serve as a mailer. Recyclable article 10 includes composite front wall 20, composite rear wall 30 (see FIG. 3), folded bottom edge 40, mouth edge 50 (providing access to interior 120; see FIG. 5), and closure flap 60. In the embodiment illustrated in FIG. 1, composite front wall 20 and composite rear wall 30 are integral at folded bottom edge 40, with composite front wall 20 and composite rear wall 30 each comprising an outer ply (herein also referred to as the “envelope film”) and an inner ply which in FIG. 1 is a cellular cushioning article made up of a “formed film” bonded to a “backing film,” as illustrated in FIGS. 5 and 6, described below. Exemplary films from which the outer ply and inner ply can be made are disclosed in examples below. Front wall 20 and rear wall 30 of the outer ply are bonded together at first lateral seal 70a and second lateral seal 70b.

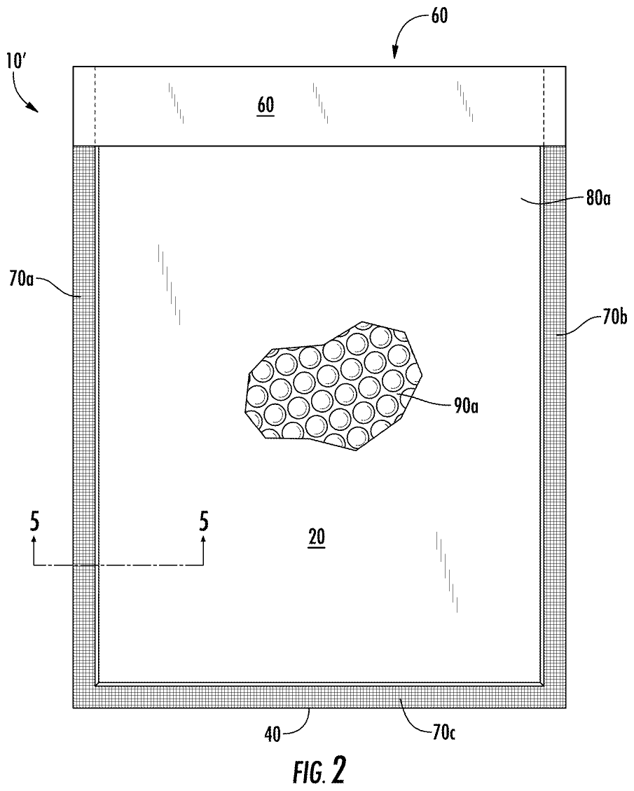

In another embodiment, the outer ply of recyclable article 10′ is constructed from two separate webs bonded together as illustrated in FIGS. 2, 3, and 4. The two webs are bonded together along their first and second lateral edges at heat seals 70a and 70b, respectively, and bonded together along bottom seal 70c. The bonded lateral seals 70a and 70b in the embodiment of FIGS. 1, 2, 3, and 4, and the bonded bottom seal 70c of the embodiment of FIGS. 2, 3, and 4 can be made via heat sealing, suitable adhesive, or radio frequency sealing, ultrasonic sealing, etc, as known to those of skill in the art.

Closure flap 60 is formed either integrally as an extension of an outer ply of composite rear wall 30, or as a discrete member that is separately made and then adhered to rear wall 30, e.g. by a suitable adhesive, heat sealing, radio frequency sealing, ultrasonic sealing, etc. If closure flap 60 is formed as an integral part of an outer play of rear wall 30, at least the outer ply of rear wall 30 is made longer than front wall 20. Closure flap 60 includes adhesive layer 100, adhered directly or indirectly to the interior surface of closure flap 60, as well as optional release tape 110, which can be made from any of a variety of suitable materials as known to those of skill in the art. The adhesive used in adhesive layer 100 can be any suitable adhesive, including pressure sensitive adhesive, adhesive activated by moisture, or adhesive activated by saliva. Suitable adhesives include thermoplastic hot melt adhesive, silicone adhesive, acrylic pressure sensitive adhesive, solvent cast adhesive, UV (ultraviolet) or EB (electron beam) cured acrylic adhesive, and the like, as known to those of skill in the art.

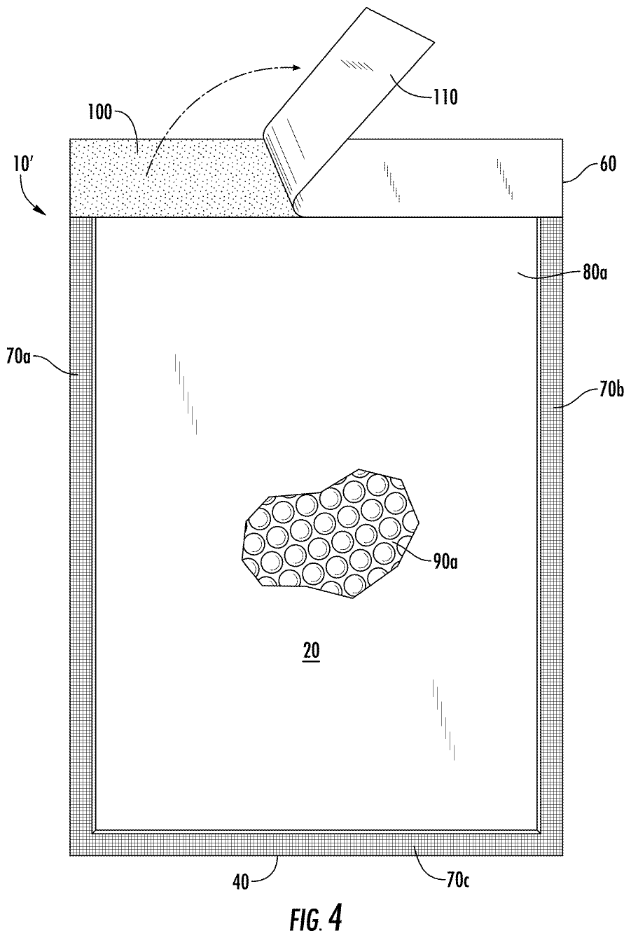

When a product (not illustrated) to be packaged and/or stored and/or shipped is placed into interior 120 of recyclable article 10, release tape 110 is peeled from closure flap 60, exposing adhesive layer 100 (FIG. 1 & FIG. 4), and closure flap 60 is folded toward front wall 20, and pressed against front wall 20 to contain the product inside recyclable article 10 and to seal and close recyclable article 10. In FIG. 2 closure flap 60 is illustrated in closed position, i.e., with adhesive layer 100 adhering closure flap 60 against an outside surface of front wall 20, thereby closing recyclable article 10.

FIG. 5 is a transverse cross-sectional cut-away view of a portion of recyclable article of FIG. 2, taken along lines 5-5 of FIG. 2. FIG. 5 illustrates composite front wall 20 having a multilayer construction comprising outer ply 80a (also referred to as envelope film 80a), inner ply 90a (also referred to as envelope film 90a), and composite rear wall 30, having a multilayer construction comprising outer ply 80b and inner ply 90b, each of which is of multilayer construction.

FIG. 6 is a schematic cross-sectional view of recyclable, composite assembly 380 representing composite front wall 20 (or rear wall 30) of FIGS. 1-4, but also represents the same components arranged in the same way as composite rear wall 30 of FIGS. 1-4. Composite assembly 380 has outer ply 80a and inner ply 90a making up front wall 20. Inner ply 90a comprises formed film 340 and backing film 350. Formed film 340 includes discrete formed regions 342 separated by land area 346. Entrapped gas (e.g., air), at ambient pressure, is present in each cell 344 between each discrete formed region 342 and backing layer 350.

Formed film 340 and backing film 350 can each be multilayer films a structure such as:
seal/tie 1/barrier/tie 2/outer,
   as disclosed in Table 3, below. The land area of formed film 340 can be thicker than backing film so that the gas transmission rate through thinner formed regions 342 is low enough to ensure a desired creep resistance.

Inner ply 90a is an assembly of the general structure of BUBBLE WRAP cellular cushioning manufactured by Sealed Air Corporation. However, inner ply 90a differs from BUBBLE WRAP cellular cushioning in that inner ply 90a, when incorporated with outer ply 80a forms composite assembly 380 which is both (i) creep-resistant under load due to presence of gas barrier layer in films of each of the films making up inner ply 90a, and (ii) polyethylene recyclable.

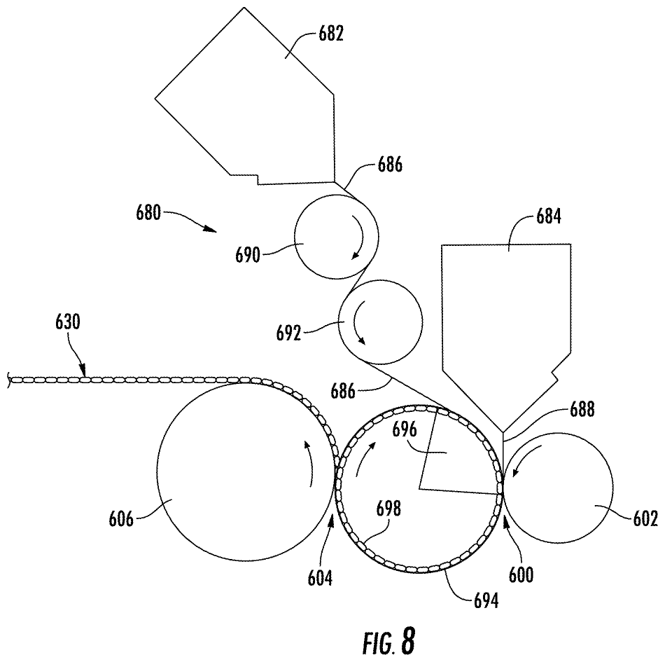

Various films from which outer plies 80a and 80b, as well as films suitable for use in both formed films and backing films of inner plies 90a and 90b, are disclosed in examples below. Film of the present invention can be made by any suitable process, such as tubular or flat cast coextrusion, hot blown extrusion, lamination, extrusion coating, or corona bonding, by techniques well known in the art, such as the processes illustrated in FIGS. 8, 17, and 18, described herein. In an embodiment none of the films comprise propylene homopolymer. In an embodiment, none of the films comprise propylene copolymer. In an embodiment, the films comprise neither propylene homopolymer nor propylene propylene copolymer.

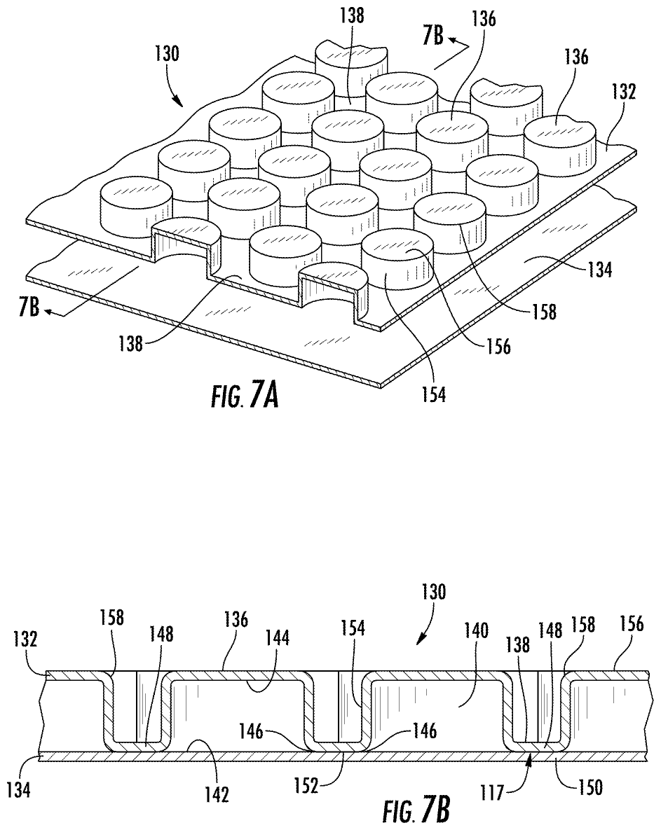

FIG. 7A is an exploded perspective view of a schematic of cellular cushioning article 130. FIG. 7B is a cross-sectional view of assembled cellular cushioning article 130, taken through section 7B-7B of FIG. 7A. Viewing FIG. 7A and FIG. 7B together, cellular cushioning article 130 includes first film 132 and second film 134. Second film 134, herein also referred to the “backing film,” is a flat film, i.e7., not thermoformed. First film 132, hereinafter also referred to as the “thermoformed film,” has discrete thermoformed regions 136, each of which has a generally circular cross-section, i.e., a circular “footprint.” Moreover, the spacing of thermoformed regions 136 is such that cellular cushioning article 130 is capable of providing flexible cushioning for an object to be surrounded thereby, or otherwise in close contact therewith.

As shown, second film 134 is adhered to first film 132 at land area 138 such that first and second films 132, 134 together form a plurality of discrete cells 140 enclosed by the plurality of inside surfaces 144 of each discrete thermoformed region 136 together with the corresponding plurality of inside surfaces of discrete regions 142 of second film 134 that remain unbonded to first film 132 and are juxtaposed opposite each discrete thermoformed region 136, together with the plurality of discrete edge regions 146 of the bond between first film 132 and second film 134.

Inside surface 148 of land area 138 of thermoformed film 132 is bonded to inside surface 150 of second film 134 at bond 152. Bond 152 is a hermetic bond that can be a heat weld, i.e., heat seal, or can be made using an adhesive applied to inside surface 148 of land area 138 and/or to the inside surface 150 of backing film 134. Hermetic bond 152 provides an airtight closure to ensure that cells 140 retain the fluid entrapped therein as land area 138 of first film 132 is bonded to inside surface 150 of second film 134 to produce bond 152. The fluid entrapped in cells 140 can be gas or liquid. In each of the examples below which are or comprise such air cells, the fluid is air.

The plurality of discrete thermoformed regions 136 in first film 132 may be made of any desired shape or configuration, with uniform or tapered walls. In various embodiments made using vacuum to draw the regions into a cavity of a forming drum, the film thickness in thermoformed regions 136 tapers, with the thinnest film being in the region in which side wall 154 transitions into top surface 156, i.e., a “rim” region 158. This thinning down of the film is not illustrated in FIG. 2. Alternatively, the thinnest portion of the film in the thermoformed region can be that portion of the thermoformed region that is farthest from the second film 134, as discussed in the above-incorporated U.S. Pat. No. 3,294,387, which is hereby incorporated, in its entirety, by reference thereto. Although thermoformed regions 136 are illustrated with a circular cross-sectional shape and a flat top, other shapes, e.g., a domed top, a half sphere or other portion of a sphere, are possible.

First film 132 may have a thickness (before thermoforming) of from about 0.5 to 10 mils, such as from 1 to 5 mils, 1 to 4 mils, etc. When second film 134 is not thermoformed, it may have a thickness of from about 0.05 to 3 mils, such as from 0.1-2 mils, 0.2 to 1 mil, etc. When second film 134 is thermoformed, its thickness may be the same or similar to first film 122, e.g., within the ranges as described immediately above relative to film 132.

Thermoformed regions 136 may have a height of from about 1 mm to 30 mm, or 6 to 13 mm, and a diameter (or major dimension) of from 2 mm to 80 mm, or from 4 mm to 35 mm. As the height and diameter of thermoformed regions 136 pockets is increased, the thickness of the land area of first film 132 may also be increased, and the thickness of flat second film 134 may also be increased.

First film 132 can be thicker (before thermoforming) than second film 134. First film 132 may have a fairly thin gauge, e.g., 0.1 to 0.5 mils, while the second film 114 may be relatively thicker and/or stiffer to lend support for the structure. Thus, any number of variations may be made in the thickness of the sealed films and the size and configuration of the formed portions, in order to attain any desired shock absorbing action.

The cellular cushioning article, having the formed film with a land area to which the backing film is bonded, can, without additional components, be converted to a cushioning article by being folded and sealed to itself to make a packaging article such as a pouch or mailer. In an embodiment, a strand of cellular cushioning article is folded to form a bottom edge and then sealed transversely with a single transverse seal, or with a closely-spaced pair of seals, leaving an open top along the film edges opposite the bottom edge fold, a first side seal up a first side edge, and a second side seal up a second side edge. The seals can be impulse seals, hot bar seals, hot wire seals, or seals of any other desired type. One side wall can have an extension which serves as a closure flap, as in the mailers described herein. Optionally, a line of weakness can be provided within some or all of the transverse seals, or between closely spaced transverse seals.

In an embodiment, the transverse seals are trim seals made with a hot wire. Trim seals made with a hot wire cut a downstream portion of the strand off of the remainder of the strand, and can bond the front wall to the rear wall on the folded strand downstream of the trim seal as well as bonding the front wall to the rear wall upstream of the trim seal.

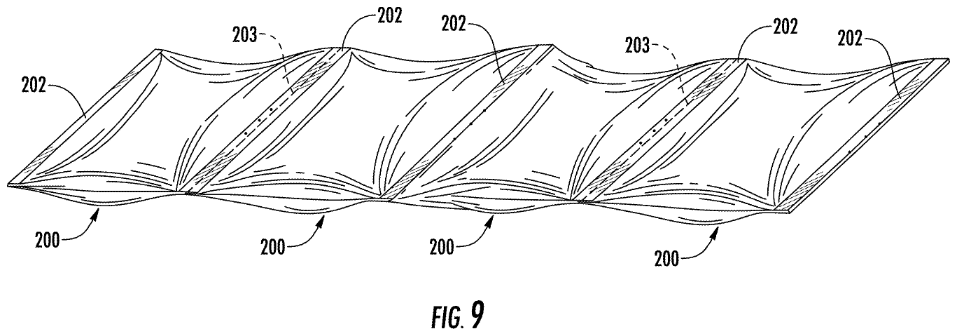

FIG. 9 illustrates a pair of inflated packaging cushions 200 made from an air impermeable thermoplastic film that is polyethylene recyclable. The cushions can be formed from a tube of material as disclosed in U.S. Pat. No. 5,942,076, hereby incorporated, in its entirety, by reference thereto. Each cushion is formed along weld lines 202 and inflated as described in U.S. Pat. No. 5,942,076. Cushions 200 are formed in a series attached to each other and may be separated along perforated line 203.

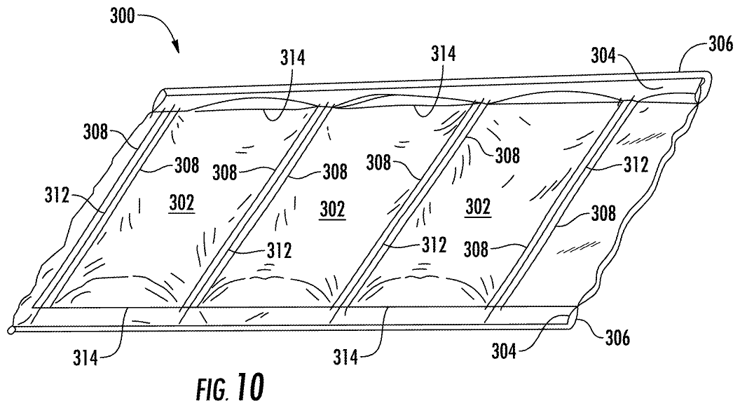

FIG. 10 illustrates an alternative embodiment in which two separate films are sealed together to make a strand of packaging cushions 300, as disclosed in U.S. Pat. No. 7,225,599, hereby incorporated, in its entirety, by reference thereto. Individual cushions 302 are made by sealing together two strands of juxtaposed film plies 304 and 306, by making transverse seals 308 and longitudinal seals 314. The cushions are inflated by sealing the films together with a series of spaced-apart transverse seals 308 and one longitudinal seal 314 along one longitudinal edge of juxtaposed strands of films 304 and 306, and thereafter blowing air into the open ends of each open cushion followed by sealing the open ends closed with second longitudinal seal 314, as disclosed in U.S. Pat. No. 7,225,599.

Although not illustrated, a strand of inflated packaging cushions could be made by folding a strand of flat film to provide a folded strand edge with two juxtaposed film leaves extending transversely therefrom with the leaves juxtaposed against each other, making transverse seals at intervals across the juxtaposed film leaves from the fold line to provide a series of open chambers each having an open end along the remaining unsealed longitudinal edge of the folded film strand, blowing air into each of the open chambers, and thereafter sealing each chamber closed along its unsealed longitudinal edge.

The various inflated packaging cushions described in the preceding three paragraphs are made from thermoplastic films designed so that the cushions are polyethylene recyclable. Moreover, the film (or at least one of the films if two different films are used) comprises a gas barrier layer to enhance the gas retention of the packaging cushions while under load during use. Depending upon the cushioning protection desired, the width and length of the cushions may vary but are generally in the range of 3″ by 3″ to 12″ by 12″ or larger.

FIG. 11 illustrates a schematic of a portion of a strand of inflatable cushioning article 418 in lay-flat configuration, i.e., before it has been inflated and sealed closed. Two sheets 420a,b having respective inner surfaces 422a,b sealed to each other in a seal pattern 424 defining a series of inflatable chambers 426 having a closed distal end 428a and an open proximal end 428b, with the open proximal ends 428b providing an inflation port 430 for each of the inflatable chambers 426. The inflatable chambers 426 are composed of a plurality of cells 434 connected by connecting channels 456, with each chamber 426 terminating at terminal cell 454. The inflatable chambers 426 are generally arrayed in a substantially transverse orientation to a longitudinal dimension 432 of the inflatable web 418. The longitudinal dimension 432 of web 418 is the longest dimension of the web (i.e., the length-wise dimension), and is generally parallel to the direction in which the supply of inflatable pouches travels through the inflation system, as described in US Pub. No. 2014-0314798, which is hereby incorporated, in its entirety, by reference thereto.

As inflatable cushioning article 418 as illustrated is a composite article made from two discrete films bonded together, the films may be the same or different in their composition and construction, but together they are designed so that the composite article is polyethylene recyclable. Alternatively, a similar inflatable cushioning article could be made using a folded flat film or from a film tubing that is slit, as described in U.S. Pat. No. 6,800,162, which is hereby incorporated, in its entirety, by reference thereto. In all these embodiments, the films are designed so that the inflatable cushioning article is polyethylene recyclable while at the same time the film has a barrier layer to allow the cushioning article to better retain air while under load. Suitable films are described in various examples below.

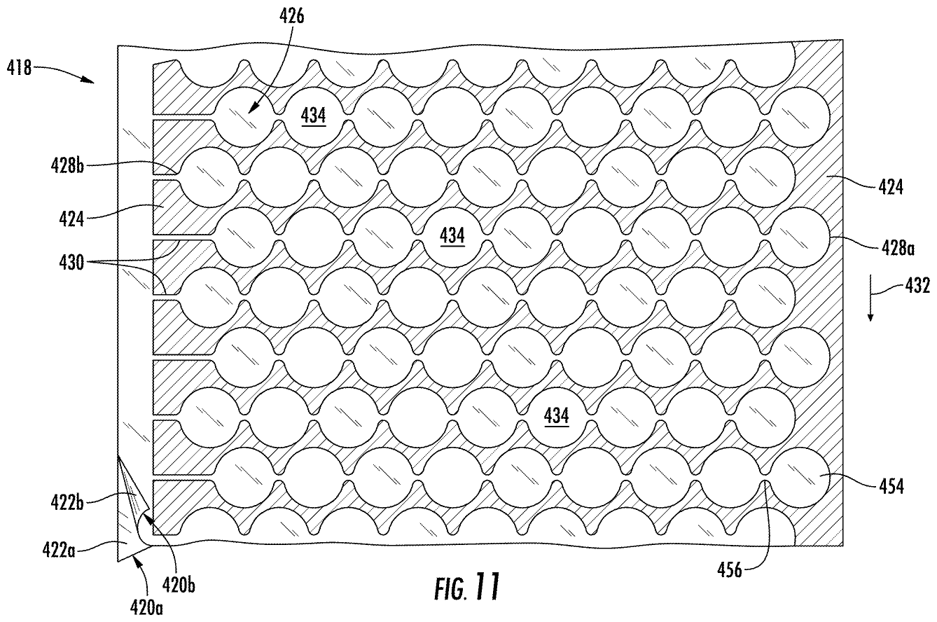

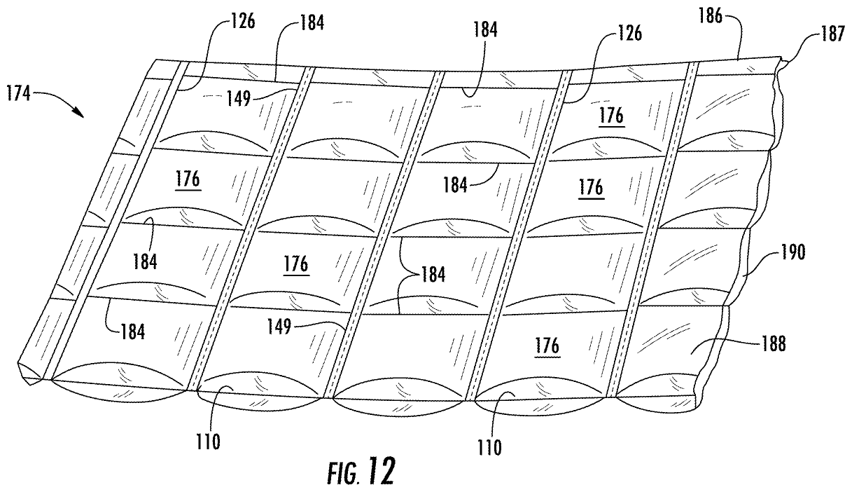

FIG. 12 illustrates a portion of a strand of cushioning article 174 comprising a grid of inflated pillows 176 separated by longitudinal seals 184 and transverse seals 126. Cushioning article 174 is made by folding a single film strand lengthwise along fold line 110 to provide two film leaves 188 and 190 extending transversely away from fold line 110. Opposite fold line 110 are first film edge 186 and second film edge 187.

As disclosed in U.S. Pat. No. 7,225,599, which is hereby incorporated, in its entirety, by reference thereto, cushioning article 174 is made by first folding the film and making a series of lengthwise seals 184, the air being blown into the channels between lengthwise seals 184. Then transverse seals 126 are made across the inflated channels to produce the grid of inflated pillows 176. The strand of cushioning article 174 may be torn transversely at a desired length using transverse lines of weakness 149. The combination of lengthwise seals 184 and transverse seals 126 allow the final “quilted” cushioning article to be thinner and more flexible for use as a cushion for packaging and other end uses, versus providing only lengthwise seals 184 or transverse seals 126.

Although inflated cushioning article 174 as illustrated and described above is made from a single folded film (the folded film could be a folded flat film, or could be derived from a film tubing slit down one edge), in another embodiment it is made from two discrete films bonded together. The two films may be the same or different in their composition and construction. However, in all embodiments the film or films are designed so that the resulting cushioning article, as a whole, is polyethylene recyclable. In all embodiments at least one of the films is provided with a barrier layer to allow the cushioning article to better retain air while under load. Various films and assemblies of films are described in examples set forth below.

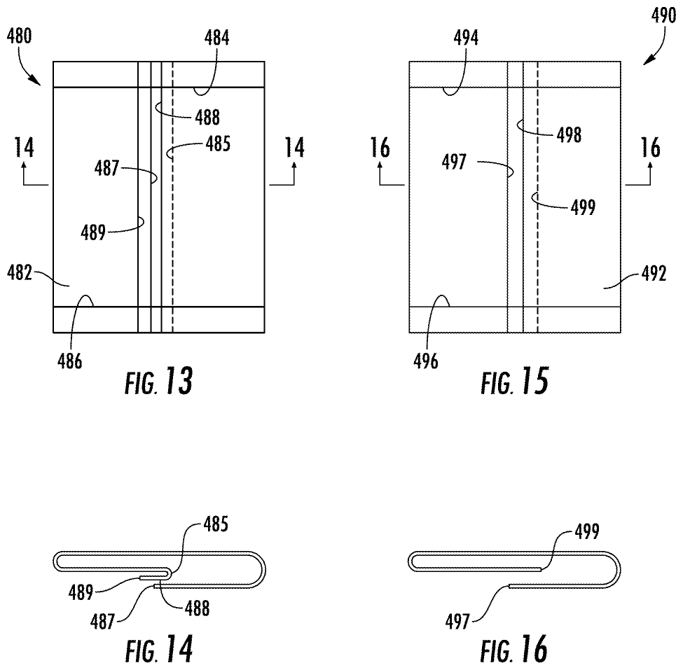

FIG. 13 and FIG. 14 together illustrate a packaging article 480 which is generated by a horizontal flow wrap process, also known as a horizontal form fill and seal process. Packaging article 480 of FIG. 13 and FIG. 14 is made from a single piece of film 482 having longitudinal edges 487 and 489 and internal longitudinal fold 485. Packaging article 480 is as disclosed in U.S. Pat. No. 6,913,809, which is hereby incorporated, in its entirety, by reference thereto. Packaging article 480 has top seal 484, bottom seal 486. Packaging article 480 has backseam fin seal 488. Fin seal 488 is not illustrated in cross-sectional view in FIG. 14. Packaging article 480 is made from a single piece of film which is polyethylene recyclable.

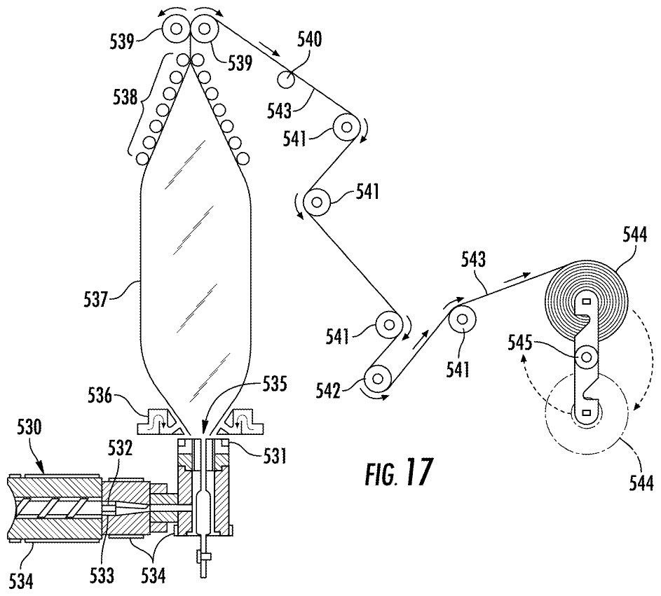

FIG. 15 and FIG. 16 together illustrate alternative flow wrap packaging article 490 which also can be generated by a horizontal flow wrap process. Packaging article 490 of FIG. 15 and FIG. 16 is also made from a single piece of film 492 having longitudinal edges 497 and 499. Packaging article 490 has top seal 494, bottom seal 496, and backseam lap seal 498. Lap seal 498 is not illustrated in cross-sectional view in FIG. 16, which is taken through section 16-16 of FIG. 15. Packaging article 490 is made from a single piece of film which is polyethylene recyclable.

The flow wrap process is carried out using a horizontal wrapping process, as is described in U.S. Publication No. 2017-0144416-A1, which publication is hereby incorporated, in its entirety, by reference thereto. Although U.S. Publication No. 2017-0144416-A1 discloses using the horizontal flow wrap process so that the packaging article remains open, this is only because of the need to evacuate the air in the meat packaging process of U.S. Publication No. 2017-0144416-A1. If modified atmosphere in the package is not required in the packaging of a product, or evacuation of atmosphere from the package is not required in the packaging of the product, the package can be sealed across both ends on the flow wrap packaging line. This is the procedure generally used to package products which do not need to be packaged under vacuum or under modified atmosphere.

### EXAMPLES

The following examples are provided to illustrate various embodiments of films, and articles made therefrom, which alone, or in combination with each other, or in combination with further undisclosed films are both (i) polyethylene recyclable, and (ii) provide a gas barrier layer. The various resins and other components used in the making of the films are provided in Table 1, below.

TABLE 1
Resins Used In Examples

| | | Resin MI (g/10 min | Resin | |
|---|---|---|---|---|
| Resin | | @190 C./2.16 kg) per | Density | |
| Identity | Resin | ASTM D1238 | g/cm³ | Supplier |
| HDPE 1 | RMS-245U ethylene octene copolymer | 1.7 | 0.945 | Nova |
| HDPE 2 | SCLAIR 2607 ethylene butene copolymer | 4.6 | 0.947 | Nova |
| HDPE 3 | Exxon HD6704.18 ethylene hexene copolymer | 4.5 | 0.952 | Exxon Mobil |
| HDPE 6 | HD 9856B ethylene butene copolymer | 0.46 | 0.957 | Exxon Mobil |
| HDPE8 | SCLAIR 17A ethylene butene copolymer | 0.45 | 0.950 | Nova |
| LDPE 1 | NOVAPOL LC-0522-A low density polyethylene | 4.5 | 0.920 | Nova |
| LDPE 2 | NOVAPOL LA-0219-A low density polyethylene | 2.3 | 0.918 | Nova |
| LDPE 3 | ESCORENE LD-200.48 low density polyethylene | 7.5 | 0.915 | Exxon Mobil |
| LDPE 4 | PETROTHENE NA963083 ethylene homopolymer | 0.7 | 0.919 | Lyondell Basell |
| P/E Cop | ATOFINA PPC 4170 propylene ethylene copolymer | 0.75 | 0.905 | Total |
| | | | | Petrochemicals |
| PA 1 | ULTRAMID C33 polyamide 6/66 | 0 (mp 196° C.) | 1.12 | BASF |
| PA 2 | AEGIS H135QP polyamide 6 | 0 (mp 215° C.) | 1.14 | AdvanSix |
| VLDPE 1 | FP112A homogeneous ethylene octene copolymer | 0.9 | .912 | Nova |
| VLDPE 2 | EXCEED 1012CA | 1.0 | .912 | Exxon Mobil |
| VLDPE 3 | EXCEED 1012HA homogeneous ethylene/hexene copolymer | 1.0 | .912 | Exxon Mobil |
| LLDPE 1 | NTX 101 heterogeneous ethylene hexene copolymer | 0.9 | 0.917 | Exxon Mobil |
| LLDPE 2 | SCLAIR FP120A ethylene octene copolymer | 1.0 | 0.920 | Nova |
| MDPE 1 | NOVAPOL TF-0438-E ethylene hexene copolymer | 4.2 | 0.938 | Nova |
| MDPE 2 | SCLAIR FP026-F linear low density polyethylene | 0.75 | 0.928 | Nova |
| TIE 1 | PLEXAR PX3236 anhydride modified LLDPE | 2.0 | 0.921 | Lyondell-Basell |
| MB-1 | 1006 white color concentrate masterbatch | 18.0 | 2.03 | Ingenia |
| MB-2 | 110069 white in LLDPE | 3.0 | 2.03 | Ampacet |
| MB-3 | ABC 2000 antiblock in low density polyethylene | 6.0 | 1.03 | Polyfil |
| MB-4 | 1073 antiblock and slip in polyethylene | 2.3 | 0.93 | Ingenia |
| MB-6 | 10562 fluoropolymer in LLDPE | 2 | .92 | Ampacet |
| MB-7 | 10562-KA PROFLOW 62A processing aid in LLDPE | 2 | .94 | Ampacet |
| MB-8 | 1065 erucamide in LLDPE | 2 | .92 | Ingenia |
| MB-9 | 1150 processing aid | 2 | .92 | Ingenia |
| MB-10 | 1051 antiblock masterbatch | 0.92 | .92 | Ingenia |
| MB-11 | 100458 fluoropolymer in LLDPE | 2.3 | .93 | Ampacet |
| MB-12 | 1070SB antiblock and slip in LLDPE | 5.5 | .98 | Ingenia |
| MB-2 | 110609 white color concentrate in LLDPE | 17 | 2.03 | Ampacet |
| RGND | LC-300 reground polymer mixture | 0-2 | 0.95-1.0 | Ameripak |
| | (contained 5% Polyamide 6 with mp 220° C.) | | | |
| PP-1 | ATOFINA PPC 4170 | 0.75 (@230° C.) | 0.905 | Total Petrochem. |

### Making the Films and Composite

Films were produced and bonded to each other to make cushioned mailers in accordance with the cushioned mailers described above and illustrated in FIGS. 1-6. Each mailer had an outer ply consisting of an envelope film which was a produced by a blown film process (illustrated in FIG. 17, described below), and an inner ply which was a cellular cushioning article consisting of a formed film bonded to a backing film.

The envelope film was produced by the blown film process illustrated in FIG. 17, which illustrates a schematic view of a process for making a “hot-blown” film, which is oriented in the melt state, and therefore is not heat-shrinkable. Although only one extruder 139 is illustrated in FIG. 17, in reality more than one extruder was utilized to make the envelope film.

In the process of FIG. 17, extruder 530 supplied molten polymer to annular die 531 for the formation of the film, which can be monolayer or multilayer, depending upon the design of the die and the arrangement of the extruder(s) relative to the die, as known to those of skill in the art. Extruder 530 was supplied with polymer pellets suitable for the formation of the film. Extruder 530 subjected the polymer pellets to sufficient heat and pressure to melt the polymer and forward the molten stream through die 531.

Extruder 530 was equipped with screen pack 532, breaker plate 533, and heaters 534. The film was extruded between mandrel 535 and die 531, with the resulting extrudate being cooled by cool air from air ring 536. The molten extrudate was immediately blown into blown bubble 537, forming a melt oriented film. The melt oriented film cooled and solidified as it was forwarded upward along the length of bubble 537. After solidification, the film tubing passed through guide rolls 538 and was collapsed into lay-flat configuration by nip rolls 539. The collapsed film tubing was optionally passed over treater bar 540, and thereafter over idler rolls 541, then around dancer roll 542 which imparted tension control to collapsed film tubing 543, after which the collapsed film tubing 543 was wound up as roll 544 via winder 545.

The cellular cushioning article was made by a process the produced the discrete formed regions having the open-bottomed, flat-topped, vertical-walled cylindrical form illustrated in FIGS. 7A and 7B, which process is described in, for example, U.S. Pat. No. 3,416,984, to Chavannes, as well as U.S. Pat. No. 9,017,799, to Chu et al, which patents are hereby incorporated, in their respective entireties, by reference thereto.

More particularly, the formed film and the backing film were produced in an integrated flat cast film process which is illustrated in FIG. 8, which is a schematic of an apparatus and process 680 for manufacturing the cellular cushioning article as illustrated in FIG. 7A and FIG. 7B. In FIG. 8, extrusion systems 682 and 684 extrude first film 686 and second film 688, respectively. After extrusion, first film 686 makes a partial wrap around tempering rollers 690 and 692, which may have a diameter of, e.g., 8 inches (i.e., 203 mm), and which serve to cool the first film and/or otherwise regulate the temperature of the first film so that it is at a desired temperature when it contacts thermoforming drum 694. Tempering rollers 690 and 692 are hollow. The flow of heat relative to one or both of tempering rollers 690 and 692 was controlled by controlling the temperature of liquid (e.g., water or oil) flowing through one or both of tempering rollers 690 and 692. For example, the water or oil flowing through the tempering rollers could be cooled (or heated) so as to enter tempering roller 690 and/or 692 at a temperature of from 40° F. to 350° F. during the process of manufacturing the cellular cushioning article. The heat flow is also affected by the rate of flow of liquid through tempering rollers 690 and/or 692. The tempering rollers can be used to cool the film to the solid state while also keeping the film hot enough to undergo thermoforming upon contact with vacuum forming drum 694. Tempering rollers 690 and 692 can be identical or different.

Upon exiting contact with second tempering roller 692, first film 686 is forwarded into contact with vacuum forming drum 694, which may be maintained at a temperature sufficient to permit first film 686 to (a) be thermoformed, (b) bond with second film 688, and (c) release (i.e., without sticking) from the surface of the forming drum 694. Often, a relatively moderate temperature, e.g., around 100° F. to 120° F. (higher temperature for larger cell volume and/or thicker thermoformed films), will suffice for the foregoing purposes, depending on a number of factors, including the temperature of first film 686 as it exits second tempering roller 692, the thickness and composition of the first film 686, the temperature of second film 688 when it contacts the inside surface of the land area of first film 686 after first film is thermoformed on forming drum 694, as may be readily and routinely determined by those having ordinary skill in the art of cellular cushioning manufacture. First film 686 may contact forming drum 680 over at least a portion, but generally all, of vacuum zone 696, during which time a plurality of discrete regions of first film 686 are drawn by vacuum into a plurality of discrete forming cavities in the surface of forming drum 694, thereby producing the plurality of discrete thermoformed regions 136 in first film 132, as illustrated in FIG. 1 and FIG. 2. The size and shape of cavities 698 in forming drum 694 control the size and shape of the thermoformed regions 136 on first film 132.

As illustrated in FIG. 8, vacuum zone 696 applied vacuum to the forming cavities via small channels (not illustrated) from vacuum zone 696 into the bottom of the forming cavities on the outside surface of forming drum 694, with the vacuum being constantly applied to the portion of forming drum 694 revolving through vacuum zone 696. That is, as forming drum 694 rotates, vacuum may be applied to the running portion of forming drum 694 which is over vacuum zone 696, such that vacuum zone 696 may be a fixed vacuum zone relative to the surface of forming drum 694, which continuously moves past/over fixed vacuum zone 696.

As the now-thermoformed first film 686 proceeded through nip 600 between forming drum 694 and pressure roller 602, it is merged with second film 688, which remains hot from having been extruded shortly before contacting now-thermoformed first film 686. While in nip 600, the backside of the land area of first film 686 (now formed) contacted a corresponding portion of second film 688, with the two films being pressed together while hot. The pressing together of films 686 and 688, together with continued and/or prior heating of films 686 and/or 688 as they together passed about half way around heated forming drum 694, and through second nip 604 between forming drum 694 and take-away roller 606, resulted in hermetic heat-seal 152 between the land area of the now thermoformed first film 686 and a corresponding portion of unformed second film 688, resulting in cellular cushioning article 130 (see FIG. 7A and FIG. 7B). The passage of cellular cushioning article 630 over take-away roller 606 pulled the formed regions of air cellular article 330 out of and off of forming roller 694.

Table 2, below, provides information on the envelope films prepared for use in making cushioned mailers.

TABLE 2
Envelope Films: Layer Arrangement, Composition, and Thickness

| Film No./ | | | | | |
|---|---|---|---|---|---|
| thickness | Seal Layer | Core #1 | Core #2 | Core #3 | Outer Layer |
| Film #1 | 73%VLDPE 3 | 86% MDPE 2 | 88% MDPE 2 | 88% MDPE 2 | 99% HDPE 6 |
| | 24% LDPE 4 | 14% MB-2 | 12% MB-2 | 12% MB-2 | 1% MB-6 |
| | 1% MB-6 | | | | |
| | 2% MB-3 | | | | |
| 2.26 mils | 0.45 mil | 0.34 mil | 0.68 mil | 0.34 mil | 0.45 mil |
| Film #2 | 73%VLDPE 3 | 86% HDPE 1 | 88% MDPE 2 | 88% MDPE 2 | 99% HDPE 6 |
| | 24% LDPE 4 | 14% MB-2 | 12% MB-2 | 12% MB-2 | 1% MB-6 |
| | 1% MB-6 | | | | |
| | 2% MB-3 | | | | |
| 2.26 mils | 20.0% tft | 15.0% tft | 30.0% tft | 15.0% tft | 20.0% tft |
| Film #3 | 73%VLDPE 3 | 86% HDPE 1 | 88% MDPE 2 | 88% MDPE 2 | 80% P/E Cop |
| | 24% LDPE 4 | 14% MB-2 | 12% MB-2 | 12% MB-2 | 19% MB-2 |
| | 1% MB-6 | | | | 1% MB-6 |
| | 2% MB-3 | | | | |
| 2.26 mils | 19.0% tft | 25.0% tft | 28.0% tft | 20.0% tft | 8.0% tft |
| Film #4 | 73% VLDPE 3 | 88% HDPE 1 | 88% LLDPE 1 | 88% LLDPE 1 | 80% P/E Cop |
| | 24% LDPE 4 | 12% MB-2 | 12% MB-2 | 12% MB-2 | 19%MB-2 |
| | 1.0% MB-6 | | | | 1% MB-6 |
| | 2.0% MB-3 | | | | |
| 2.26 mils | 19.0% tft | 25.0% tft | 28% tft | 20% tft | 8.0% tft |
| Film #5 | 69% VLDPE 3 | 88% HDPE 1 | 28% LLDPE 1 | 50% LLDPE 1 | 84% HDPE 1 |
| | 24% LDPE 4 | 12.0% MB-2 | 28% VLDPE 3 | 15% MB-2 | 15% MB-2 |
| | 1% MB-6 | | 12% MB-2 | 35% HDPE 1 | 1% MB-6 |
| | 6% MB-3 | | 35% HDPE 1 | | |
| 2.26 mils | 19% tft | 19% tft | 26% tft | 26% tft | 22% tft |
| Film #6 | Seal Layer | Core Layer | Outer Layer | — | — |
| | 90% VLDPE 1 | 100% VLDPE 1 | 88% HDPE 1 | | |
| | 3% MB-9 | | 12% MB-1 | | |
| | 3% MB-10 | | | | |
| | 4% MB-8 | | | | |
| 2.4 mils | 0.24 mil | 0.24 mil | 1.92 mil | | |
| Film #7 | Seal Layer | 1st Core Layer | 2nd Core Layer | Outer Layer | — |
| | 90% VLDPE 1 | 100% VLDPE 1 | 60% HDPE 8 | 100% HDPE 8 | |
| | 3% MB-9 | | 28% LLDPE 2 | | |
| | 3% MB-10 | | 12% MB-1 | | |
| | 4% MB-8 | | | | |
| 2.4 mils | 0.24 mil | 0.24 mil | 1.44 mil | 0.48 mil | |
| Film #8 | Seal Layer | Core Layer | Outer Layer | — | — |
| | 68% VLDPE 3 | 100% VLDPE 3 | 88% HDPE 1 | | |
| | 25% LDPE 4 | | 12% MB-2 | | |
| | 1% MB-6 | | | | |
| | 6% MB-3 | | | | |
| 2.30 mils | 0.23 mil | 0.23 mil | 1.84 mils | | |
| Film #9 | Seal Layer | Core Layer | Outer Layer | — | — |
| | 88% HDPE 1 | 100% VLDPE 2 | 73% VLDPE 2 | | |
| | 12% MB-2 | | 24% LDPE 4 | | |
| | | | 2% MB-3 | | |
| | | | 1% MB-7 | | |
| 2.30 mils | 1.84 mils | 0.23 mil | 0.23 mil | | |
| Film #10 | Seal Layer | Core Layer | Outer Layer | — | — |
| | 88% HDPE 1 | 100% VLDPE 1 | 90% VLDPE 1 | | |
| | 12% MB-1 | | 24% LDPE 4 | | |
| | | | 4% MB-8 | | |
| | | | 3% MB-9 | | |
| | | | 3% MB-10 | | |
| 2.30 mils | 1.84 mils | 0.23 mil | 0.23 mil | | |

“Tft” is total film thickness

Table 3, below, provides information on the air cellular films made

TABLE 3
Air Cellular Films: Layer Arrangement, Composition, and Thickness

| | | | | | | PA | |
|---|---|---|---|---|---|---|---|
| Film No./ | | Inter-mediate | | Inter-mediate | | Wt % | PA mp |
| Total mils | Seal Layer | Layer #1 | Core Layer | Layer #2 | Outer Layer | (TVB) | (° C.) |
| Films #11 | 65.0% HDPE 2 | 100% TIE1 | 100% PA 1 | 100% TIE 1 | 65.0% HDPE 2 | 5.2 | 196 |
| 1.70 mils | 25.0% LDPE 1 | 0.0425 mil | 0.085 mil | 0.0425 mil | 25.0% LDPE 1 | | |
| | 10.0% RGND | | | | 10.0% RGND | | |
| | 0.765 mil | | | | 0.765 mil | | |
| Films #12 | 65.0% HDPE 2 | 100% TIE1 | 100% PA 2 | 100% TIE 1 | 65.0% HDPE 2 | 5.2 | 215 |
| 1.70 mils | 25.0% LDPE 1 | 0.0425 mil | 0.085 mil | 0.0425 mil | 25.0% LDPE 1 | | |
| | 10.0% RGND | | | | 10.0% RGND | | |
| | 0.765 mil | | | | 0.765 mil | | |
| Films #13 | 65.0% HDPE 2 | 100% TIE1 | 100% PA 2 | 100% TIE 1 | 65.0% HDPE 2 | 5.2 | 215 |
| 1.70mils | 25.0% LDPE 3 | 0.0425 mil | 0.085 mil | 0.0425 mil | 25.0% LDPE 3 | | |
| | 10.0% RGND | | | | 10.0% RGND | | |
| | 0.765 mil | | | | 0.765 mil | | |
| Films #14 | 65.0% HDPE 2 | 100% TIE1 | 100% PA 2 | 100% TIE 1 | 65.0% HDPE 2 | 5.2 | 215 |
| TFT: | 25.0% LDPE 2 | 0.0425 mil | 0.085 mil | 0.0425 mil | 25.0% LDPE 2 | | |
| 1.70 mils | 10.0% RGND | | | | 10.0% RGND | | |
| | 0.765 mil | | | | 0.765 mil | | |
| Films #15 | 64.0% HDPE 2 | 100% TIE1 | 100% PA 1 | 100% TIE 1 | 64.0% HDPE 2 | 5.2 | 196 |
| TFT: | 33.0% LDPE 2 | 0.0425 mil | 0.085 mil | 0.0425 mil | 33.0% LDPE 2 | | |
| 1.70 mils | 3.0% MB-4 | | | | 3.0% MB-4 | | |
| | 0.765 mil | | | | 0.765 mil | | |
| Films #16 | 64.0% HDPE 2 | N/A | N/A | N/A | N/A | 0 | N/A |
| (monolayer) | 33.0% LDPE 2 | | | | | | |
| 1.70 mils | 3.0% MB-4 | | | | | | |
| | 1.7 mils | | | | | | |
| Films #17 | 67.0% MDPE 1 | 100% TIE1 | 100% PA 2 | 100% TIE 1 | 67.0% MDPE 1 | 1.2 | 215 |
| TFT: | 30.0% LDPE 2 | 0.0425 mil | 0.085 mil | 0.0425 mil | 30.0% LDPE 2 | | |
| 1.70 mils | 3.0% MB-12 | | | | 3.0% MB-11 | | |
| | 0.765 mil | | | | 0.765 mil | | |

“Films” includes thermoformed film and backing film; the TFT (total film thickness) was the combined thickness of the thermoformed film in the land area plus the thickness of the backing film. The backing film had a thickness which was 67% of the thickness of the thermoformed film.

The flat top of each formed region of the cellular cushioning article was heat bonded to the inside surface of the envelope film to make a composite assembly which was used to make the front wall 20 and the rear wall 30 of composite article 10 which was designed to be converted to a cushioned mailer as illustrated in FIGS. 1-6, described above, via the cutting, folding and sealing required to make the cushioned mailer 10 of FIG. 1. Lamination was conducted by passing the envelope film in partial wrap around a hot roller (about 118° C.) with diameter of 23.75 inches at speed of 60 ft/min, followed by merging the bubble assembly into contact with the hot outer film, with the tops of the bubbles contacting the hot outer film and heat bonding to the hot outer film.

A pressure sensitive adhesive (PSA) was coated along one machine direction edge (MD edge) of the envelope film with a release liner added over the PSA. The resulting three-film laminate was folded in and sealed to make a folded bottom with side seals, with the envelope film extending to provide a closure flap coated on its inside surface with the pressure sensitive adhesive with the release liner thereover. The film thicknesses of the envelope film, the thermoformed film, and the backing film were as provided in Tables 2 and 3, above.

The envelope film was made by a process as illustrated in FIG. 17, which illustrates a schematic view of a process for making a non-heat shrinkable film, i.e., a “hot-blown” film, which is oriented in the melt state and is not heat shrinkable. Although only one extruder 530 is illustrated in FIG. 17, there can be more extruders, such as 2 or 3 extruders. Extruder 530 supplies molten polymer to annular die 531 for the formation of the film, which can be monolayer or multilayer, depending upon the design of the die and the arrangement of the extruder(s) relative to the die, as known to those of skill in the art. Extruder 530 is supplied with polymer pellets (not illustrated) suitable for the formation of the film. Extruder 530 subjects the polymer pellets to sufficient heat and pressure to melt the polymer and forward the molten stream through die 531.

Extruder 530 is equipped with screen pack 532, breaker plate 533, and heaters 534. The film is extruded between mandrel 535 and die 531, with the resulting extrudate being cooled by cool air from air ring 536. The molten extrudate is immediately blown into blown bubble 537, forming a melt oriented film. The melt oriented film cools and solidifies as it is forwarded upward along the length of bubble 537. After solidification, the film tubing passes through guide rollers 538 and is collapsed into lay-flat configuration by nip rollers 539. The collapsed film tubing is optionally passed over treater bar 540, and thereafter over idler rollers 541 and around dancer roller 542 which imparts tension control to collapsed film tubing 543, after which collapsed film tubing 543 is wound up as roll 544 via winder 545.

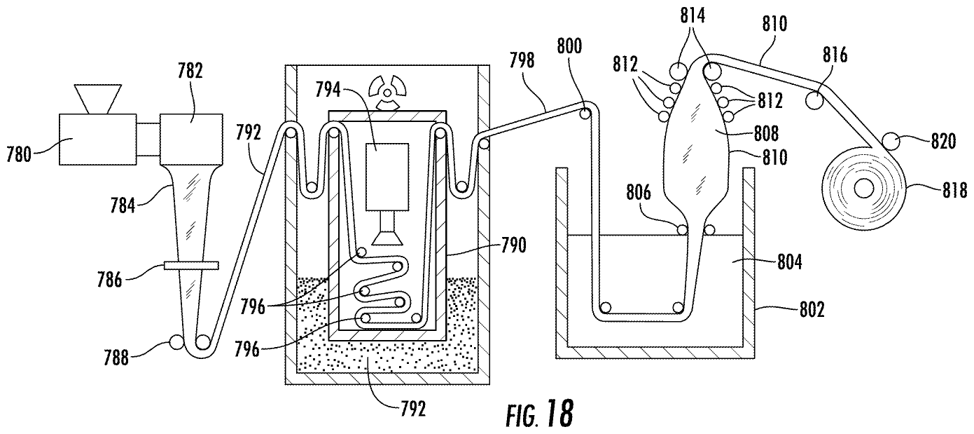

Alternatively, any of the polyethylene recyclable films described herein can be made by the process illustrated in FIG. 18, which is a schematic of a process used to make a heat-shrinkable film such as could be used to make a heat-shrinkable bag. The process of FIG. 18 utilizes solid state orientation to produce polymer stress at a temperature below the melting point, whereby the resulting oriented film is heat shrinkable. Optionally, the heat-shrinkable film can be annealed by any suitable process known to those of skill in the art, to produce a solid-state oriented film that has less heat shrinkability, or is even non-heat shrinkable, i.e., has a combined longitudinal+transverse free shrink (i.e., total free shrink) of less than 10 percent at 85° C., with the heat-shrinkability being measured in accordance with ASTM D2732, which is hereby incorporated, in its entirety, by reference thereto. The solid-state orientation of the polymers in the oriented films produced in accordance with the process of FIG. 18 can have a higher strength as a result of the solid state orientation, relative to hot blown films and cast films that are not oriented in the solid state.

In the process illustrated in FIG. 18, solid polymer beads (not illustrated) are fed to a plurality of extruders 780 (for simplicity, only one extruder is illustrated). Inside extruders 780, the polymer beads are forwarded, melted, and degassed, following which the resulting bubble-free melt is forwarded into die head 782, and extruded through annular die, resulting in tubing 784 which can be, for example, 5-40 mils thick, or 20-30 mils thick, or about 25 mils thick.

After cooling or quenching by water spray from cooling ring 786, tubing 784 is collapsed by pinch rolls 788, and is thereafter fed through irradiation vault 790 surrounded by shielding 792, where tubing 784 is irradiated with high energy electrons (i.e., ionizing radiation) from iron core transformer accelerator 794. Tubing 784 is guided through irradiation vault 790 on rolls 796. Preferably, the irradiation of tubing 784 is at a level of about 7 MR.

After irradiation, irradiated tubing 798 is directed over guide roll 800, after which irradiated tubing 798 passes into hot water bath tank 802 containing water 804. The now collapsed irradiated tubing 798 is submersed in the hot water for a retention time of at least about 5 seconds, i.e., for a time period in order to bring the film up to the desired temperature, following which supplemental heating means (not illustrated) including a plurality of steam rolls around which irradiated tubing 798 is partially wound, and optional hot air blowers, elevate the temperature of irradiated tubing 798 to a desired orientation temperature of from about 240° F. to about 250° F. Thereafter, irradiated film 798 is directed through nip rolls 806, and bubble 808 is blown, thereby transversely stretching irradiated tubing 798. Furthermore, while being blown, i.e., transversely stretched, irradiated film 798 is drawn (i.e., in the longitudinal direction) between nip rolls 806 and nip rolls 814, as nip rolls 814 have a higher surface speed than the surface speed of nip rolls 806. As a result of the transverse stretching and longitudinal drawing, irradiated, biaxially-oriented, blown tubing film 810 is produced, this blown tubing preferably having been both stretched at a ratio of from about 1:1.5-1:6, and drawn at a ratio of from about 1:1.5-1:6. More preferably, the stretching and drawing are each performed at a ratio of from about 1:2-1:4. The result is a biaxial orientation of from about 1:2.25-1:36, more preferably, 1:4-1:16.

While bubble 808 is maintained between pinch rolls 806 and 814, blown tubing 810 is collapsed by rolls 812, and thereafter conveyed through nip rolls 814 and across guide roll 816, and then rolled onto wind-up roll 818. Idler roll 820 assures a good wind-up.

After the cellular cushioning article and the envelope film were produced, a composite assembly was prepared by heat laminating the cellular cushioning article to the envelope film. More particularly, the flat top of each formed region of the cellular cushioning article was heat bonded to the inside surface of the envelope film, to make a composite assembly which was used to make the front wall 20 and the rear wall 30 of the composite article which was designed to be converted to a cushioned mailer as illustrated in FIGS. 1-6, described above, via the cutting, folding and sealing required to make the cushioned mailer 10 of FIG. 1. Lamination was conducted by passing the envelope film in partial wrap around a hot roller (about 118° C.) with diameter of 23.75 inches at speed of 60 ft/min, followed by merging the bubble assembly into contact with the hot outer film, with the tops of the bubbles contacting the hot outer film and bonding to the hot outer film. A pressure sensitive adhesive (PSA) was coated along one machine direction edge (MD edge) of the envelope film with a release liner added over the PSA. The resulting three-film laminate was folded in and sealed to make a folded bottom with side seals, with the envelope film extending to provide a closure flap coated on its inside surface with the pressure sensitive adhesive with the release liner thereover. The film thicknesses of the envelope film, the thermoformed film, and the backing film are as provided in Tables 2 and 3, above. The various mailers and other articles prepared were tested for composite melt index and creep resistance in the manner set forth below.

### Melt Index Testing

The tools and equipment utilized in the Composite Melt Index Test include: (i) DYNISCO Melt Indexer Model LMI 5000 melt flow indexer, with 2.16 kg of ergonomic stackable weights (ii) die cleaning and packaging rods (iii) wire brush for cleaning polymer residue off of the piston (iv) bit or brush for cleaning the die (v) cotton patches for cleaning the chamber (vi) spatula for cutting specimens (vii) funnel for pouring resins (viiii) go/no-go gauge for checking die (die was checked every 6 months) (ix) aluminum pan (x) analytical balance accurate to 0.0001 gram, checked periodically to ensure that it was level (xi) stop watch (optional as DYNISCO Melt Indexer has a built-in timer); (xii) die plug (used if extrudate is flowing too fast).

In advance of and in preparation for the running of each melt index test (whether single resin melt index test or composite article melt index test), the DYNISCO Melt Indexer was kept turned on continuously. In advance of each test, the plunger was pulled out of the barrel holding the top insulator, and the die was pushed out and checked for cleanliness. Both the die and the plunger were cleaned before each test was conducted. The die and plunger were placed back in the barrel and reheated before each test was initiated.

Melt index measurements of individual resins, as disclosed above in Table 1, were carried out in accordance with ASTM D1238, the disclosure of which is hereby incorporated, in its entirety, by reference thereto. In Table 1, the melt indices of the individual resins are disclosed as g/10 min @190 C and 2.16 kg, per ASTM D1238.

### Polyethylene Recyclability Determination Via Composite Melt Index

The Composite Melt Index Test is a “composite test” in that it is carried out on an entire article to be recycled. The Composite Melt Index Test is not a test carried out on a single resin present in an article to be recycled, or on a single component of an article to be recycled. Rather, the Composite Melt Index Test is always carried out on an article comprising two or more different resins in combination, and in this sense is a “composite” test.

The Composite Melt Index Test can be carried out on a multilayer film that is sealed to itself to make an article which may be, for example, a packaging article. Such articles include (i) uncushioned envelopes (e.g., mailers), (ii) form-fill-seal packaging articles (e.g., packaging articles made by wrapping a film around a product and bonding (e.g., heat sealing) the film to itself along the length of the article to form a backseamed tubing together with bonding the film to itself across upstream and downstream of the upstream and downstream ends of the product inside the backseamed tubing, so that the product is sealed with and surrounded by the resulting packaging article, and even (iii) cushioning articles such as fluid filled articles made, for example, by heat sealing a multilayer film to itself (e.g., air pillows, air cellular cushioning, etc) to make a packaging article, i.e., an article useful in packaging. The fact that the film is a multilayer film with at least two layers which differ in polymeric composition makes this melt index test an example of the Composite Melt Index Test. An article formed by bonding a multilayer film to itself, is considered to be a “first degree composite article”

Alternatively, the Composite Melt Index Test can be carried out on an assembly comprising a multilayer film which serves as a first component of the assembly, with the first component being bonded (e.g., heat sealed) to a second component of the assembly. The second component can have a polymeric composition which is the same as or different from the first component. If the first component and the second component are both identical multilayer films (another example of a first degree composite article), with each multilayer film having at least two layers which differ in polymeric composition, carrying out the melt index test on the assembly is a Composite Melt Index Test in that at least two different polymers are present in the assembly.

On the other hand, the Composite Melt Index Test can be carried out on an assembly of a first component (a multilayer film with at least two layers which differ in chemical composition) and a second component which has a different polymeric composition from the first component. Such an assembly article is a “second degree composite” in sense that it is a composite of a first component first and second components that are compositionally different. For example, a cushioned mailer as described in FIG. 1 is a second degree composite in that it is an assembly of an outer envelope film first component and an inner cushioning article second component which itself is an assembly of a thermoformed film and an backing film. The phrase “second degree composite” is also inclusive of composites with three or more components with at least three of the three or more components being compositionally different from each other. Thus, carrying out a melt index test on the entire cushioned mailer article to be recycled is another example of the Composite Melt Index Test.

### Composite Melt Index Test Procedure

The Composite Melt Index Test was carried out on composite articles (including first and second degree composite articles) by first cutting the composite article into strips followed by manually stuffing the strips into the barrel of a DYNISCO Melt Indexer Model LMI 5000 melt flow indexer, which was pre-calibrated by running a DuPont Elvax 3128 resin standard to make sure that the melt index fell within the 1.90-1.98 g/10 min range. If the composite article comprises fluid-filled chambers (i.e., chambers filled with gas or liquid), all chambers were burst before or as the composite article was cut into pieces of a size suitable to be manually stuffed into the barrel of the melt flow indexer.

Once a plurality of strips of a sample were cut, at least 4 test strips were manually stuffed into the barrel (inside diameter of 50.8 mm) of the melt flow indexer. Once the strips were in the barrel of the melt flow indexer, they were heated to 190° C. with the polyolefin therein melting so that the test strips formed a molten mass that was de-gassed by having the 2.16 kg weight on top of the piston for at least 390 seconds, which ensured that all gas bubbles exited the molten mass inside the barrel of the melt flow indexer before the material was allowed to flow through the die.

After degassing, the molten mass inside the barrel was allowed to flow down to the 2 mm orifice in the die inside the melt flow tester. The die thickness was 8 mm, which corresponded with the length of the 2 mm diameter passageway through the die. The test procedure measured the rate at which plastic flowed through the 8 mm long 2 mm diameter passageway through the die, while the plastic was heated to a temperature of 190 C and while the plastic was under a load of 2.16 kg. Unless otherwise specified, the melt index test procedure was carried out in accordance with ASTM D1238. The Composite Melt Index test results reported in Table 4 represent an average of the composite melt index values obtained by repeating the composite melt index test three times on the composite article.

### Creep Testing of Fluid Chamber Cushioning Articles

The tools and equipment utilized in the Creep Test include: (i) Modified Korstner static-load box per ASTM D2221 consisting of (a) a Base Plate (outer box) with load surface dimensions of 8″×6.5″ and a height of 10″ and (b) Movable Guided Platen with external dimensions of 6⅜″×6⅜″; (ii) precisely 16.0 pounds total load weight including movable guided platen, top aluminum plates and additional weights; (iii) 8″×6.5″ aluminum plates, each being about 0.25 inch thick; and (iv) a dial caliper providing 0.001 inch graduations.

Each Mailer Tested was treated as follows. First, 4 samples were cut from each mailer tested. Two samples were cut from each of the two sides of the mailer. Each sample was 4″+/−¼ inch, square. Because the cells in successive rows were staggered to increase the cell density per unit area of cushioning article, the cutting of the 4-inch on square samples cut through approximately half of the bubbles.

Second, one aluminum plate, 8 inch long by 6.5 inch wide by 0.25 inch thick and weighing about 565 grams was placed, in a central region of the Base Plate. The four samples were stacked on the plate, one directly on top of another, as a single stack. Each sample was placed bubble side up into the stack. The stack of the four samples was placed in a central region of the plate.

After the four samples were stacked over in a central region of the top surface of the aluminum base plate, an aluminum top plate, also 8 inch long by 6.5 inch wide by 0.25 inch thick and also weighing about 565 grams, was placed on top of the stack of samples so that the stack of samples was directly under a central region of the top plate. Thereafter, about 14.8 pounds of added weights were placed on top of the top plate in a manner so that the top plate remained “balanced,” i.e., so that the top plate remained substantially parallel to the bottom plate. The combined weight of the upper plate (about 1.2 pounds) and the added weights (about 14.8 pounds) was approximately 16 pounds. In this manner, each of the 4 samples in the stack was placed under a static load of 1 psi.

For each stack, an initial height measurement was taken using a dial caliper. The initial height measurement was taken after the stack of four samples was under the load of the top plate and weights for a period of 60 minutes, plus or minus 5 minutes. The initial height measurement was made by measuring the distance between the bottom plate and the top plate, the measurements being made at each of the four corners of the metal plate on top of the stack. The distance measured was from the top surface of the bottom plate to the bottom surface of the top plate. The four distance values were averaged, with the resulting height determination being designated as the initial height of the samples.

After leaving the stack of samples under the load for a total of 96 hours, plus or minus 2 hours, the final height of the samples was measured. The final height measurement was conducted in the same manner the initial height measurement. That is, the distance between the top of the bottom plate and the bottom of the top plate was again measured at each of the four corners, with the values averaged to obtain a single distance representing the final height.

The creep test was carried out at ambient room temperature and 1 atm ambient pressure, and was carried out in accordance with ASTM D2221, which is hereby incorporated, in its entirely, by reference thereto.

Creep loss was calculated by subtracting the final height from the initial height, and thereafter dividing that height difference by the initial height, thereby calculating the fractional loss of the initial height. That fractional loss was multiplied by 100 to obtain the percent creep loss.

Calculated Composite Melt Index of Composite Article

Even though present only at a level up to 10 wt % (total composite article weight basis) the type and amount of the second polymer can affect both the polyethylene recyclability and the creep resistance of the composite article. The “remaining polymers” in the composite article, i.e., the polymers other than the one or more second polymers of the second layer, make up at least 90 wt % of the composite article.

As such, these remaining polymers can affect the polyethylene recyclability of the composite article. If the melt index of the remaining polymers is too low, the composite article will have a composite melt index below 0.5 g/10 min @190° C. and 2.16 kg, per ASTM D1238, and the composite article will not be polyethylene recyclable. On the other hand, if the melt index of the remaining polymers is too high, the composite article will have a composite melt index above 4 g/10 min @190° C. and 2.16 kg, per ASTM D1238, and the composite article will not be polyethylene recyclable.

It has been found that if the selected type and selected amount of the remaining polymers is carried out in such a way that the resulting Calculated Composite Melt Index of the Remaining Polymers is within the range of from 2 to 7 g/10 min @190° C. and 2.16 kg, per ASTM D1238, the composite article is more likely to be polyethylene recyclable. The likelihood of polyethylene recyclability is even higher if Calculated Composite Melt Index of the Remaining Polymers is within the range of from 2.5 to 3.5 g/10 min @190° C. and 2.16 kg, per ASTM D1238.

The Calculated Composite Melt Index of the Remaining Polymers is carried out by determining the melt index of each of the remaining polymers that has a melt index at 190° C., together with the amount of each of the remaining polymers that has a melt index at 190° C., and calculate the Composite Melt Index of the entire group of remaining polymers on a weighted basis, i.e., each of the Remaining Polymers contributes to the Calculated Composite Melt Index of Remaining Polymers in an amount determined by multiplying the melt index (@190° C. and 2.16 kg) of each Remaining Polymer with the wt % of that Remaining Polymer relative to the total weight of the Remaining Polymers. In this manner, the Calculated Composite Melt Index of Remaining Polymers can be determined.

Table 4, below, provides information on the polyethylene recyclability of various composite articles including: (i) Mailer No. 1 (a comparative cushioned mailer lacking a barrier layer in the air cellular films); (ii) Mailer No. 2 (a cushioned PAC AIRJACKET mailer); (iii) Mailer Nos. 3-12, each being a composite of various films described above in Tables 2 and 3; and (iv) Air Cushioning composite No. 1, made from Film No. 17. Table 4 also provides the Measured Composite Melt Index of the composite article, and the Calculated Composite Melt Index of the Remaining Polymers. In Table 4, the film composition provided is the overall composition of the film with all layers combined together, as occurs during recycling.

TABLE 4
PE Recycle, Composite Melt Index, and Creep-Resistance for Mailers

| | | | | | Calculated | | |
|---|---|---|---|---|---|---|---|
| | RCY¹ | | | | Composite | | % Creep- |
| | (YES or NO) | | | Measured | Melt Index of | Barrier | Resist. |
| | C-R² | | | Composite | Remaining | (B) | 1 psi for |
| | (YES or NO) | Envelope Film | Bubble Films | Melt Index | Polymers | Non- | 96 hrs, |
| Sample | amount PA (wt %) | Composition | Compos. | (190° C./ | (190° C./ | barrier | per ASTM |
| Identity | mp PA (° C.) | (wt %, TFB) | (wt %, TFB) | 2.16 kg) | 2.16 kg) | (NB) | D2221 |
| Mailer | RCY: NO | 31% PP 1 | 60-50% LLDPE 1 | 0 | N/C | B | <20 |
| No. 1 | C-R: YES | 56% HDPE 3 | 15% LDPE 3 | | | | |
| (prior art) | 0.51 wt % | 12% MB 2 | 15-25% RGND | | | | |
| | PA6 @220 C. | 1% MB 5 | 5% Nylon 2 | | | | |
| | 2.6 wt % | | 5% Tie 1 | | | | |
| | PA2 @215 C. | | | | | | |
| Mailer | RCY: YES | ~60% HDPE | ~55% HDPE | 0.58 | N/C | NB | 74.2 |
| No. 2 | C-R: NO | ~40% LLDPE | ~45% LLDPE | | | | |
| (prior art) | 0 wt % PA | | | | | | |
| Mailer | RCY: NO | Film #9 | Film #11 | 0.24 | 2.69 | B | N/T |
| No. 3 | C-R: N/T³ | 70.4% HDPE 1 | 58.5% HDPE 2 | | | | |
| | 0.23 wt % | 17.3% VLDPE 2 | 22.5% LDPE 1 | | | | |
| | PA6 @220 C. | 9.6% MB 2 | 9% RGND | | | | |
| | 2.6 wt % | 2.4% LDPE 4 | 5% Tie 1 | | | | |
| | PA1 @196 C. | 0.2% MB 3 | 5% Nylon 1 | | | | |
| | | 0.1% MB-7 | | | | | |
| Mailer | RCY: NO | Film #10 | Film #11 | 0.12 | 3.59 | B | N/T |
| No. 4 | C-R: N/T³ | 70.4% HDPE 1 | 58.5% HDPE 2 | | | | |
| | 0.23 wt % | 19% VLDPE 1 | 22.5% LDPE 1 | | | | |
| | PA6 @220 C. | 9.6% MB-1 | 9% RGND | | | | |
| | 2.6 wt % | 0.4% MB-8 | 5% Tie 1 | | | | |
| | PA1 @196 C. | 0.3% MB-9 | 5% Nylon 1 | | | | |
| | | 0.3% MB-10 | | | | | |
| Mailer | RCY: NO | Film #6 | Film #12 | 0 | 3.63 | B | N/T |
| No. #5 | C-R: N/T³ | 71.6% HDPE 1 | 58.5% HDPE 2 | | | | |
| | 0.23 wt % | 17.6% VLDPE 1 | 22.5% LDPE 1 | | | | |
| | PA6 @220 C. | 9.8% MB-1 | 9% RGND | | | | |
| | 2.6 wt % | 0.4% MB-8 | 5% Nylon 2 | | | | |
| | PA2 @215 C. | 0.3% MB-9 | 5% Tie 1 | | | | |
| | | 0.3% MB-10 | | | | | |
| Mailer | RCY: NO | Film #6 | Film #13 | 0 | 3.87 | B | N/T |
| No. 6 | C-R: N/T³ | 71.6% HDPE 1 | 58% HDPE 2 | | | | |
| | 0.23 wt % | 17.6% VLDPE 1 | 22% LDPE 3 | | | | |
| | PA6 @220 C. | 9.8% MB-1 | 9% RGND | | | | |
| | 3.0 wt % | 0.4% MB-8 | 6% Nylon 2 | | | | |
| | PA2 @215 C. | 0.3% MB-9 | 5% Tie 1 | | | | |
| | | 0.3% MB-10 | | | | | |
| Mailer | RCY: NO | Film #6 | Film #14 | 0 | 3.105 | B | N/T |
| No. 7 | C-R: N/T³ | 71.6% HDPE 1 | 58% HDPE 2 | | | | |
| | 0.23 wt % | 17.6% VLDPE 1 | 22% LDPE 2 | | | | |
| | PA6 @220 C. | 9.8% MB-1 | 9% RGND | | | | |
| | 3.0 wt % | 0.4% MB-8 | 6% Nylon 2 | | | | |
| | PA2 @215 C. | 0.3% MB-9 | 5% Tie 1 | | | | |
| | | 0.3% MB-10 | | | | | |
| Mailer | RCY: NO | Film #7 | Film #12 | 0 | 2.84 | B | N/T |
| No. 8 | C-R: N/T³ | 57.0% HDPE 8 | 58.5% HDPE 2 | | | | |
| | 0.23 wt % | 17.3% VLDPE 1 | 22.5% LDPE 1 | | | | |
| | PA6 @220 C. | 17.3% LLDPE 2 | 9% RGND | | | | |
| | 2.6 wt % | 7.4% MB-1 | 5% Nylon 2 | | | | |
| | PA2 @215 C. | 0.4% MB-8 | 5% Tie 1 | | | | |
| | | 0.3% MB-9 | | | | | |
| | | 0.3% MB-10 | | | | | |
| Mailer | RCY: YES | Film #5 | Film #15 | 0.52 | 2.77 | B | 18.8 |
| No. 9 | C-R: YES | 50% HDPE 1 | 57% HDPE 2 | | | | |
| | 3.0 wt % | 37% LLDPE 1 | 29% LDPE 2 | | | | |
| | PA1 @196 C. | 11% MB-2 | 6% Nylon 1 | | | | |
| | | 2% MB-3 | 6% Tie 1 | | | | |
| | | | 2% MB-4 | | | | |
| Mailer | RCY: YES | Film #8 | Film #15 | 0.78 | 2.89 | B | 18.8⁴ |
| No. 10 | C-R: N/T³ | 70.4 HDPE 1 | 57% HDPE 2 | | | | |
| | 3.0 wt % | 16% VLDPE 3 | 29% LDPE 2 | | | | |
| | PA1 @196 C. | 11% MB-2 | 6% Nylon 1 | | | | |
| | | 2% MB-3 | 6% Tie 1 | | | | |
| | | | 2% MB-4 | | | | |
| Mailer | RCY: N/T | Film #5 | Film #16 | N/T (but | 2.77 | NB | 79.8* |
| No. 11 | C-R: NO | 50% HDPE 1 | 59% HDPE 2 | believed to be | | | |
| | 0.26 wt % | 37% LLDPE 1 | 28% LDPE 2 | polyethylene | | | |
| | PA6 @220 C. | 11% MB-2 | 10% RGND | recyclable) | | | |
| | | 2% MB-3 | 3% MB-4 | | | | |
| Mailer | RCY: N/T | Film #8 | Film #16 | N/T | 2.89 | NB | N/T |
| No. 12 | C-R: N/T | 50% HDPE 1 | 59% HDPE 2 | | | | |
| | 0.26 wt % | 37% LLDPE 1 | 28% LDPE 2 | | | | |
| | PA6 @220 C. | 11% MB-2 | 10% RGND | | | | |
| | | 2% MB-3 | 3% MB-4 | | | | |
| Air Cellular | RCY: NO | NOT | Film #17 | 0.06 | 3.57 | B | N/T |
| Cushioning | C-R: N/T | PRESENT | 63.5% MDPE 1 | | | | |
| Article No. 1 | 1.2 wt % | | 28.4% LDPE 2 | | | | |
| | PA2 @215 C. | | 4% TIE 1 | | | | |
| | | | 1.4% MB-11 | | | | |
| | | | 1.4% MB-12 | | | | |
| | | | 1.2% PA 2 | | | | |

¹RCY = polyethylene recyclable (Composite Melt Index of from 0.5 to 4 g/10 min at 190° C. and 2.16 kg)
²C-R = creep-resistance upon 1 psi load for 96 hrs is <20% (yes or no)
N/T: composite article Not Tested
N/T³: composite article not creep tested but should exhibit C-R <20% per polyamide layer in cellular film
18.8⁴: based on creep test from same cellular cushioning article in Composite Article No. 9
N/C: not calculated for composite article
TFB: total film weight basis
“*”cells completely empty at end of test; remaining thickness due only to collapsed films

### Results: The Composite Articles of Table 4

Mailer Nos. 1 and 2 in Table 4 are prior art commercial mailers. Mailer Nos. 3-12 of Table 4 were made by combining Films Nos. 1-10 of Table 2 with Film Nos. 11-16 of Table 3. Air Cellular Cushioning Article No. 1 of Table 4 was made by heat bonding a 1.0 mil formed film having the layer arrangement and composition of Film No. 17 with a flat film of the same layer arrangement, but only 2/3 as thick as the formed film, i.e., 0.7 mil was the thickness of the backing film.

The results in Table 4 include data related to the polyethylene recyclability (herein abbreviated as “RCY”) for each of Mailer Nos. 1-10 and Air Cellular Cushioning Article No. 1. Polyethylene recyclability was not tested for Mailer Nos. 11 and 12. Whether the composite article is designated Polyethylene Recyclable was determined by whether the composite article exhibited a Measured Composite Melt Index of from 0.5 to 4 grams/10 min at 190° C. and 2.16 kg using the Composite Melt Index Test described hereinabove.

The only composite articles which tested as polyethylene recyclable (i.e., had a Composite Melt Index within the range of from 0.5 to 4 g/10 min @ 190° C. and 2.16 kg) were Mailer No. 2, Mailer No. 9, and Mailer No. 10. Mailer Nos. 1 and 3-8, and Cellular Cushioning Article No. 1, exhibited a Composite Melt Index less than 0.5 g/10 min @ 190° C. and 2.16 kg, and hence were not deemed to be polyethylene recyclable.

Mailer Nos. 6 and 7 contained a total of 3.23 wt % (total composite weight basis) of two different polyamide 6 polymers having melting points of 215° C. or 220° C. respectively, i.e., melting points of 15° C. and 20° C. higher than the melt index test temperature, and each of these composites exhibited a Composite Melt Index of 0 g/10 min @190° C. and 2.16 kg. Mailer No. 8 contained a total of 2.83 wt % (total composite weight basis) of two different polyamide 6 polymers having melt points of 215° C. and 220° C., respectively. Mailer No. 1 contained 3.3 wt % of the polyamide 6 with the melt point of 215° C., and 1 wt % of polyamide 6/66 having a melt point of 196° C., with Mailer No. 1 also exhibiting a Composite Melt Index of 0 g/10 min @190° C. and 2.16 kg.

Although Cellular Cushioning Article No. 1 contained only 0.61 wt % of a polyamide 6 having a melting point of 215° C., it exhibited a Composite Melt Index of only 0.06 g/10 min @190° C. and 2.16 kg, showing that just 0.61 wt % polyamide 6 with a melt point of 215° C. prevented the entire composite article from being polyethylene recyclable.

In contrast, Mailer Nos. 9 and 10 were polyethylene recyclable. They exhibited a Composite Melt Index of 0.52 and 0.76 g/10 min @190° C. and 2.16 kg, respectively. This was unexpected and unpredictable in view of the results for Cellular Cushioning Article No. 1, which was rendered non-polyethylene recyclable with only 0.61 wt % (total composite article wt basis) polyamide 6 having amp of 215° C. More particularly, whereas Mailer No. 9 and Mailer No. 10 each contained 3.0 wt % polyamide 6/66 (total composite article wt basis) having a melting point of 196° C., it was unexpected and unpredictable that the inclusion of 3.0 wt % polyamide with a melt point of 196° C. (6° C. above the composite melt index test temperature) exhibited polyethylene recyclability (composite melt indexes of 0.52 and 0.76 g/10 min @190° C. and 2.16 kg, respectively, whereas just 0.61 wt % polyamide 6 with melt point of 220° C. (30° C. above the composite melt index test temperature) rendered Cellular Cushioning Article No. 1 non-polyethylene recyclable with a composite melt index of only 0.06 g/10 min @190° C. and 2.16 kg.

A further comparison of Mailer Nos. 9 and 10 with Mailer Nos. 3 and 4 reveals a high degree of sensitivity to polyethylene recyclability of the composite to the presence of just 0.23 wt % polyamide 6 having a melt point of 220° C. (total composite wt basis) in combination with 2.1 wt % polyamide 6/66 with a mp of 196° C. (total composite wt basis). That is, even though Mailer Nos. 3 and 4 had 0.9 wt % less polyamide 6/66 (mp 196° C.) relative to Mailer Nos. 9 and 10, the presence of only 0.23 wt % of polyamide 6 (mp 220 C) in Mailer Nos. 3 and 4 was enough to take the composite melt index down from 0.52 and 0.78 g/10 min @190° C. and 2.16 kg (Mailer Nos. 9 and 10, respectively) to a composite melt index of 0.24 and 0.12 g/10 min @190° C. and 2.16 kg (Mailer Nos. 3 and 4, respectively). It was unexpected and unpredictable that just 0.23 wt % polyamide 6 mp 220° C. (total composite basis) would have lowered the composite melt index so much that Mailer Nos. 3 and 4 were rendered non-polyethylene recyclable.

Although the creep resistance of Mailer No. 10 was not measured, it was expected that it will exhibit a creep resistance approximately equivalent to the creep resistance of Mailer Nos. 9, because the air cellular films of Mailer Nos. 9 and 10 were identical. In the composite articles of Table 4, creep-resistance is dependent solely upon the barrier properties of the air cellular films.

Viewing all of the composite articles included in Table 4, only Mailer Nos. 9 and 10 exhibit both polyethylene recyclability and creep resistance less than 20%. Prior art Mailer No. 1 exhibits creep resistance but is not polyethylene recyclable. Mailer Nos. 3-8, and Cellular Cushioning Article No. 1, are also not polyethylene recyclable. Prior art Mailer No. 2 is polyethylene recyclable but is not creep resistant. Mailer No. 11 is not creep-resistant, as it has no barrier layer. Although Mailer No. 12 was not tested for creep-resistance, the same cellular cushioning films were used in Mailer No. 12 that were used in Mailer No. 12. Thus, the creep resistance results for Mailer No. 11 should apply equally to Mailer No. 12, which is therefore expected not to exhibit a creep-resistance of less than 20% upon being subjected to a load of 1 psi for 96 hours.

In summary, the data above establishes that the inventors have discovered articles exhibiting unexpected results. First, the inventors have discovered a composite article which unexpectedly is polyethylene recyclable while containing a substantial quantity of a polymer having a melting point higher than the test conditions at which polyethylene recyclability is determined. Neither of the prior art composite articles were both polyethylene recyclable and contained a substantial quantity of a polymer having a melting point higher than the test conditions at which polyethylene recyclability is determined.

Second, the inventors have discovered a composite article which comprises cellular cushioning, the composite article unexpectedly: (i) being polyethylene-recyclable, in combination with (ii) comprising cellular cushioning that exhibits a creep-resistance of less than 20% upon being subjected to a load of 1 psi for 96 hours. Neither of the prior art cellular cushioning articles were both polyethylene recyclable and exhibited creep-resistance of less than 20% upon being subjected to a load of 1 psi for 96 hours.

1. A polyethylene recyclable composite article comprising a multilayer film comprising:
A. a first layer comprising a first polymer, the first polymer comprising at least one polyolefin having a melting point ≤190° C., and
B. a second layer comprising a second polymer selected from the group consisting of:
(b)(i) amorphous polyamide having a Tg of from 120° C. to 180° C.,
(b)(ii) polyamide having a melting point of from 191° C. to 205° C.,
(b)(iii) polyvinylidene chloride having a melting point of from 191° C. to 205° C., and
(b)(iv) ethylene/vinyl alcohol copolymer having a melting point of from 191° C. to 205° C., and
C. a tie layer comprising at least one tie polyolefin selected from the group consisting of ethylene/unsaturated ester, modified polyolefin, and homogeneous ethylene/alpha-olefin copolymer, the tie layer being between the first layer and the second layer;
D. wherein:
(c)(i) the multilayer film is bonded to itself
or
(c)(ii) the multilayer film is a first discrete component of the composite article and the multilayer film is bonded to a second discrete component of the composite article; and
the second polymer is present in the composite article in an amount of from 1 to 10 wt % based on total composite article weight, and the composite article exhibits a composite melt index of from 0.5 to 4 grams/10 min at 190° C. and 2.16 kg in a Composite Melt Index Test.

2. The composite article according to claim 1, wherein the multilayer film is bonded to itself.

3. The composite article according to claim 2, wherein the bond of the multilayer film to itself a heat seal of the multilayer film to itself.

4. The composite article according to claim 3, wherein the composite article is a form fill seal packaging article comprising:
(a) a backseam heat seal of the film to itself, the backseam heat seal running the length of the composite article, the backseam heat seal being a first heat seal;
(b) a first end seal of an inside layer of the film to itself, the first end seal being at a first end of the composite article, the first end seal being a second heat seal; and
(c) a second end seal of an inside layer of the film to itself, the second end seal being at a second end of the composite article, the second end seal being a third heat seal.

5. (canceled)

6. (canceled)

7. The composite article according to claim 2, wherein the multilayer film is bonded to itself to form a closeable envelope suitable for use as a mailer, the composite article comprising:
a bottom fold of the multilayer film, the bottom fold of the multilayer film defining: a bottom of the composite article, a front wall portion of the multilayer film extending from a first side of the bottom fold to a transverse top edge of the front wall, and a rear wall portion of the multilayer film extending from a second side of the bottom fold to a transverse top edge of the rear wall;
the front wall portion of the multilayer film having a front wall inside layer facing the rear wall, and the rear wall portion of the multilayer film having a rear wall inside layer facing the front wall;
a first portion of the front wall inside layer bonded to a first portion of the rear wall inside layer to make a first lateral bond along a first side edge of the article;
a second portion of the front wall inside layer bonded to a second portion of the rear wall inside layer to make a second lateral bond along a second side edge of the article; and
an open mouth for receiving a product, the open mouth defined at least in part by a transverse top edge of the front wall.

8-10: (canceled)

11. The composite article according to claim 1, wherein:
the multilayer film is a first multilayer film which forms a front wall of the composite article, the composite article further comprises a second film which forms a rear wall of the composite article;
the first multilayer film and the second film are bonded to each other at a bottom seal defining a bottom, a first lateral seal along a first side edge, and at a second lateral seal along a second side edge, with the front wall extending from the bottom seal to a transverse top edge of the front wall, with the rear wall extending from the bottom seal to a transverse top edge of the rear wall, and
the composite article further comprises an open mouth for receiving a product, the open mouth being defined at least in part by the transverse top edge of the front wall.

12-16. (canceled)

17. The composite article according to claim 7 wherein:
the front wall has a length corresponding with a distance from the bottom to the transverse top edge of the front wall, and
the rear wall has a length corresponding with a distance from the bottom to a transverse top edge of the rear wall,
the length of the front wall is equal to the length of the rear wall, and
the transverse top edge of the front wall and the transverse top edge of the rear wall define the open mouth for receiving the product.

18. (canceled)

19. (canceled)

20. The composite article according to claim 1, wherein the multilayer film is sealed to itself or another film in an assembly having at least closed one fluid-filled chamber, with the assembly being a cushioning article and wherein the multilayer film is a first multilayer film which is a formed film having a plurality of formed regions separated by a land area, and the composite article is a cellular cushioning article further comprising a second film that is a backing film bonded to a land area of the formed film, so that a plurality of closed fluid-filled chambers are between the first multilayer film and the second film.

21. The composite article according to claim 20, wherein the second film is a second multilayer film comprising:
(A) a third layer comprising a third polymer, the third polymer comprising polyolefin having a melting point ≤190° C., and
(B) a fourth layer comprising a fourth polymer selected from the group consisting of:
(b)(i) amorphous polyamide having a Tg of from 120° C. to 180° C.,
(b)(ii) polyamide having a melting point of from 191° C. to 205° C.,
(b)(iii) polyvinylidene chloride having a melting point greater than 191° C. to 205° C., and
(b)(iv) ethylene/vinyl alcohol copolymer having a melting point of from 191° C. to 205° C.

22. (canceled)

23. (canceled)

24. The composite article according to claim 20, wherein the cellular cushioning article is laminated to an envelope film to form a cellular cushioning laminate and:
the cellular cushioning laminate is in a folded configuration and has a fold defining:
(i) a bottom of the composite article,
(ii) a front wall extending from a first side of the bottom fold,
(iii) a rear wall extending from a second side of the bottom fold, and
the front wall faces the rear wall, wherein:
(iv) a first portion of the front wall is bonded to a first portion of the rear wall to make a first lateral bond along a first side edge of the composite article;
(v) a second portion of the front wall is bonded to a second portion of the rear wall to make a second lateral bond along a second side edge of the composite article; and
the cellular cushioning article has an open mouth for receiving a product, the open mouth defined at least in part by a transverse top edge of the front wall.

25-30: (canceled)

31. The composite article according to claim 20, wherein the cellular cushioning article is laminated to an envelope film to form a cellular cushioning laminate and:
the cellular cushioning laminate is a first cellular cushioning laminate and the envelope film is a first envelope film and the cushioning article is a first cushioning article and the first cellular cushioning laminate forms a front wall of the composite article;
the composite article further comprises a second cellular cushioning laminate forming a rear wall of the cellular cushioning article, the second cellular cushioning laminate comprising a second envelope film laminated to a second cellular cushioning article;
the first cellular cushioning laminate and the second cellular cushioning laminate are bonded to each other at a bottom seal defining a bottom, at a first lateral seal along a first side edge, and at a second lateral seal along a second side edge,
the composite article further comprises an open mouth for receiving a product, the open mouth being defined at least in part by a transverse top edge of the front wall.

32-39: (canceled)

40. The composite article according to claim 20 wherein the cellular cushioning article is laminated to an envelope film to form a cellular cushioning laminate and:
the front wall has a length corresponding with a distance from the bottom to the transverse top edge of the front wall, and
the rear wall has a length corresponding with a distance from the bottom to a transverse top edge of the rear wall,
the length of the front wall is equal to the length of the rear wall, and
the transverse top edge of the front wall and the transverse top edge of the rear wall define the open mouth for receiving the product.

41-44: (canceled)

45. The composite article according to claim 20, wherein:
the cellular cushioning article is a first cellular cushioning article that forms a front wall of the composite article;
the composite article further comprises a second cellular cushioning article that forms a rear wall of the composite article;
the first cellular cushioning article and the second cellular cushioning article are bonded to each other at a bottom seal defining a bottom, at a first lateral seal along a first side edge, and at a second lateral seal along a second side edge,
the composite article further comprises an open mouth for receiving a product, the open mouth being defined at least in part by a transverse top edge of the front wall.

46-55: (canceled)

56. The composite article according to claim 1, wherein the multilayer film is sealed to itself in an assembly having at least closed one fluid-filled chamber, with the assembly being a cushioning article and the cellular cushioning article is an inflatable cellular cushioning article; and wherein the inflatable article comprises the multilayer film in a folded configuration, the multilayer film being bonded to itself in a seal pattern defining a series of inflatable chambers having a closed distal end and an open proximal end providing an inflation port for each inflatable chamber, with each inflatable chamber comprising a plurality of inflatable cells connected by inflatable connecting channels, with each chamber terminating at a terminal cell.

57. (canceled)

58. The composite article according to claim 1, wherein the multilayer film is sealed to another film in an assembly having at least closed one fluid-filled chamber, with the assembly being a cushioning article and the cellular cushioning article is an inflatable cellular cushioning article; and wherein the multilayer film is a first multilayer film and the inflatable article further comprises a second multilayer film, and the first multilayer film is bonded to the second multilayer film in a seal pattern defining a series of inflatable chambers having a closed distal end and an open proximal end providing an inflation port for each inflatable chamber, with each inflatable chamber comprising a plurality of inflatable cells connected by inflatable connecting channels, with each chamber terminating at a terminal cell wherein the second multilayer film comprises:
(A) a first layer comprising a first polymer, the first polymer comprising polyolefin having a melting point ≤190° C., and
(B) a second layer comprising a second polymer selected from the group consisting of:
(b)(i) amorphous polyamide having a Tg of from 120° C. to 180° C.,
(b)(ii) polyamide having a melting point of from 191° C. to 205° C.,
(b)(iii) polyvinylidene chloride having a melting point greater than 191° C. to 205° C., and
(b)(iv) ethylene/vinyl alcohol copolymer having a melting point of from 191° C. to 205° C.

59-70. (canceled)

71. The composite article according to claim 1, wherein the multilayer film is sealed to itself or another film in an assembly having at least closed one fluid-filled chamber, with the assembly being a cushioning article and wherein the cushioning article is a strand comprising a matrix of closed fluid-filled chambers and wherein the multilayer film is a first multilayer film and the strand comprising the matrix of fluid-filled chambers comprises both the first multilayer film and a second multilayer film, with an inside layer of the first multilayer film being bonded to an inside layer of the second multilayer film at (i) a first edge seal running along a first lengthwise edge of the strand (ii) a second edge seal running along a second lengthwise edge of the strand, (iii) at least one internal seal running the length of the strand, the internal seal being between the first edge seal and the second edge seal, and (iv) a plurality of lateral seals across the strand.

72. The composite article according to claim 71, wherein the second multilayer film comprises:
(A) a first layer comprising a first polymer, the first polymer comprising polyolefin having a melting point ≤190° C., and
(B) a second layer comprising a second polymer selected from the group consisting of:
(b)(i) amorphous polyamide having a Tg of from 120° C. to 180° C.,
(b)(ii) polyamide having a melting point of from 191° C. to 205° C.,
(b)(iii) polyvinylidene chloride having a melting point greater than 191° C. to 205° C., and
(b)(iv) ethylene/vinyl alcohol copolymer having a melting point of from 191° C. to 205° C.

73. (canceled)

74. (canceled)

75. The composite article according to claim 56, wherein upon filling the inflatable chambers with air and sealing them closed to provide an inflated cushioning article, the inflated chambers exhibit a creep resistance of less than 50% when placed under a load of 1 psi for 96 hours, the percent creep resistance being carried out in accordance with ASTM D2221.

76-80: (canceled)

81. The composite article according to claim 1, wherein the polyolefin having a melting point ≤190° C. comprises at least one member selected from the group consisting of high density polyethylene, linear low density polyethylene, medium density polyethylene, low density polyethylene, very low density polyethylene, ethylene/alpha-olefin copolymer having a density less than 0.92 g/cc, homogeneous ethylene/alpha-olefin copolymer, and polypropylene and wherein the composite article has a total polyolefin content of from 90 to 99 wt % based on total composite article weight.

82-84: (canceled)

85. A polyethylene recyclable multilayer film comprising:
(A) a first layer comprising a first polymer, the first polymer comprising polyolefin having a melting point ≤190° C., and
(B) a second layer comprising a second polymer selected from the group consisting of:
(b)(i) amorphous polyamide having a Tg of from 120° C. to 180° C.
(b)(ii) polyamide having a melting point of from 191° C. to 205° C.,
(b)(iii) polyvinylidene chloride having a melting point greater than 191° C. to 205° C., and
(b)(iv) ethylene/vinyl alcohol copolymer having a melting point of from 191° C. to 205° C.
(C) a tie layer comprising at least one tie polyolefin selected from the group consisting of ethylene/unsaturated ester, modified polyolefin, and homogeneous ethylene/alpha-olefin copolymer, the tie layer being between the first layer and the second layer; and
wherein the second polymer is present in the multilayer film in an amount of from 1 to 10 wt % based on total film weight, and wherein the multilayer film exhibits a composite melt index of from 0.5 to 4 grams/10 min at 190° C. and 2.16 kg in a Composite Melt Index Test.

86-94: (canceled)
